(19) United States
(12) Patent Application Publication
(10) Pub. No.: US 2008/0057364 A1
(43) Pub. Date: Mar. 6, 2008

(54) Fuel cell device, control device, and program cross-reference to related applications

(75) Inventor: Atsushi Yamaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/727,846

(22) Filed: Mar. 28, 2007

(30) Foreign Application Priority Data
Sep. 6, 2006 (JP) 2006-241831

(51) Int. Cl. H01M 8/04; G05B 21/02

(52) U.S. Cl. 429/23; 700/266

(57) ABSTRACT

A fuel cell device comprises a determining unit determining a steady state of a fuel cell in which fuel of fuel cell is circulated and electrical power of the fuel cell has reached a specified power, a measuring unit measures fuel temperature in the fuel cell, a fuel storing unit stores the fuel supplied to the fuel cell, and a controller controlling a concentration of the fuel stored in the fuel storing unit on the basis of the measured fuel temperature after determining the fuel cell is in the steady state.

### RELATED APPLICATIONS

This application claims the benefit of Japanese Patent Application No. 2006-241831, filed Sep. 6, 2006, in the Japanese Intellectual Property Office, the disclosure of which is incorporated herein by reference.

### BACKGROUND OF THE INVENTION

1. Field of the Invention

The present invention relates to a fuel cell device utilizing liquid fuel or the like and particularly to a fuel cell device suitable as a power source of a personal computer and a portable terminal or the like, a control device thereof, a control method, and a program thereof.

2. Description of the Related Art

A fuel cell is formed in a structure where a polymer electrolyte film is arranged, separating anode and cathode sides. On the anode side, a fuel pole is arranged for supplying fuel to the anode, which uses a catalyst to split electrons from the atoms of the fuel and transmits the electrons to the cathode side, where an air pole is arranged, thus forming a circuit. Liquid fuel, including hydrogen, an element such as a methanol aqueous solution or the like, is supplied to the fuel pole, while air, having an oxygen element, is supplied to the air pole. The anode side transmits electrons from, for example, electrons split from the hydrogen liquid fuel supplied to the fuel pole, for coupling with, for example, oxygen in the air supplied to the air pole. A fuel cell functions by electrons, remaining in the hydrogen within the liquid fuel, being guided out to the external side as electricity through the coupling explained above.

In such a fuel cell, when methanol is used for the liquid fuel, water (vapor) is generated in the air pole side a through reaction between hydrogen and oxygen and, moreover, carbon dioxide (CO₂) is generated in the fuel pole side through decomposition of methanol. When power generation is executed by an ideal chemical transformation consuming methanol of 1 mol and water of 1 mol in the fuel pole side and oxygen of 1 mol in the air pole side in the process explained above, water of 3 mols is generated in the air pole side, while carbon dioxide of 1 mol is generated in the fuel pole side.

In the fuel cell device provided with a fuel cell as explained above, a fuel tank is necessary in order to supply liquid fuel to the fuel cell. When a high concentration fuel is used, the size of the fuel tank can be reduced, but higher performance is required from the electrolyte film. When performance of the electrolyte film is not high, and if high concentration fuel is used, fuel consumption increases and power generation efficiency is lowered. Moreover, when high concentration fuel is used, the operational life of structural materials of the fuel cell, for example, the electrolyte film, catalyst material such as carbon held by platinum at a single end thereof, and bonding material for bonding these elements is likely shortened. Therefore, a fuel in concentration of about 1 mol is recommended as a result of the background explained above. A high concentration fuel is accommodated within a fuel tank and this fuel is reduced to the concentration of about 1 mol. In this case, water is necessary as a dilution liquid and a diluted solution tank for accommodating the fuel diluted by the water is also necessary to dilute the high concentration fuel. When a fuel cell is driven, the fuel is consumed. Therefore, a water level of the fuel tank is monitored with a water-level sensor, concentration of fuel is monitored with a concentration sensor, and an amount of additional supply of water and fuel is controlled on the basis of the result of the monitoring.

Accordingly, as shown in FIG. 2, a fuel cell device utilizing an ordinary liquid fuel comprises, a circulation pump 12 for supplying fuel of constant concentration to a fuel cell 1, a concentration monitoring mechanism 17A for management of concentration of the fuel to be supplied, and a high concentration fuel supply pump 13 and a dilution liquid supply pump 14 for supplying fuel or water when the detected fuel concentration is not in the constant concentration.

As a method for keeping constant the concentration of fuel, various methods have been proposed, in which fuel or water is supplied to keep the concentration constant using a densitometer, fuel is additionally supplied, as much as is consumed by detecting the amount of fuel used, and fuel concentration is controlled depending on a liquid fuel temperature of the fuel cell.

For the fuel cell technology utilizing a densitometer, a complicated calculation or situation analysis for setting of concentration considering the situation is required in parallel with temperature measurement considering influence of change in the power generating capability by temperature and with voltage measurement considering influence of change in temperature due to change of load.

As explained above, complicated control is required for management of the concentration of fuel supplied to a fuel cell. Therefore, a method for controlling the liquid temperature of the fuel cell (see, for example, Japanese Unexamined Patent Application Publication No. 1993-258760), and a method for always realizing operation in the optimum concentration by momentarily switching the fuel supplied to the negative pole depending on the temperature of the power generation cell (see, for example, Japanese Unexamined Patent Application Publication No. 2006-4868), etc. have been proposed, in place of the concentration control which has been executed as the operation control element of a fuel cell.

The operation control device of liquid fuel cell in Japanese Unexamined Patent Application Publication No. 1993-258760 is provided with a thermometer for a fuel tank of the fuel cell core of a liquid fuel cell device to measure fuel temperature in the fuel tank 1 at a predetermined time. When liquid temperature has exceeded a predetermined value, the pure water in the water tank is supplied to the fuel tank, and when liquid temperature becomes equal to a lower limit value or less, the liquid water in the preliminary fuel tank is supplied to the fuel tank to continue the operation by maintaining the fuel temperature to almost a constant value.

In Japanese Unexamined Patent Application Publication No. 1993-258760, concentration and temperature of fuel can be maintained simultaneously to the predetermined range of values, but it does not explain the timing in which the temperature should be detected after passage of a certain time from start of power generation of a fuel cell.

Accordingly, it is assumed in the fuel cell device of JP1993-258760, that information measured with a float sensor and a thermometer of the fuel tank after activation of a fuel cell is transferred to a controller and the ON-OFF operation is triggered with the signal from the controller to supply the fuel or pure water to the fuel tank. However, in this case, concentration and temperature of the fuel can be maintained simultaneously for the predetermined range of values but a program for measuring and controlling the temperature must be operated from the time of starting the activation. Therefore, the process explained above has a problem that highly efficient operation cannot be realized because electricity is used for temperature measurement.

Meanwhile, the fuel cell system of Japanese Unexamined Patent Application Publication No. 2006-4868 always assures operation in the optimum concentration by storing a low concentration fuel to mainly realize power generation reaction and a high concentration fuel to mainly realize power generation reaction and the reaction for temperature rise of power generation cell into individual storing vessels and by momentarily switching the fuel supplied to the negative pole in accordance with temperature of power generation cell.

Namely, in this fuel cell system, the temperature is measured and controlled from the time of starting activation of the fuel cell, the high concentration fuel is supplied to the power generation cell at the time of activation, and the fuel supplied to the power generation cell is switched to the low concentration fuel when the normal operation starts. In this fuel cell activating method, since major portions are placed under the management of the fuel cell system as a whole, the criterion such as timing for switching of the supply of high concentration fuel and low concentration fuel is ambiguous, followed by a problem that fuel is likely to be used uneconomically.

### SUMMARY OF THE INVENTION

Additional aspects and/or advantages of the invention will be set forth in part in the description which follows and, in part, will be apparent from the description.

Considering the background explained above, it is an object of the present invention to realize stable operation by simplifying control of power generation by a fuel cell through control thereof only with temperature under the steady state. Moreover, it is also an object of the present invention to provide a system for always operating a fuel cell using the fuel in the optimum concentration under the condition that the fuel cell device is adequately activated to obtain stable output in a steady state.

The present invention relates to a fuel cell device which can judge fuel failure such as fuel concentration failure, etc. by detecting temperature in the fuel cell only when the fuel cell provides an output in the steady state. Moreover, since only a temperature sensor is monitored, a highly sophisticated processor is no longer required. As a result, the fuel cell device of the present invention is useful because all processes can be realized with a low function, low price and low power consumption processor.

Considering the background explained above, it is an object of the present invention to realize stable operation by simplifying control in regard to power generation by a fuel cell through control thereof only with temperature under the steady state. Moreover, it is also an object of the present invention to provide a system for always operating a fuel cell using the fuel in the optimum concentration under the condition that the fuel cell device is adequately activated to obtain a stable output under the steady state.

The present invention relates to a fuel cell device which can judge fuel failure, such as fuel concentration failure, etc., by detecting temperature in the fuel cell only when the fuel cell provides an output in the steady state. Moreover, since only a temperature sensor is monitored, a highly sophisticated processor is no longer required. As a result, the fuel cell device of the present invention is useful because all processes can be realized with a low function, low price and low power consumption processor.

The fuel cell device of the present invention comprises a judging means for judging the steady state of a fuel cell in which the fuel of the fuel cell is circulated and the electrical power from the fuel cell reaches the specified power, a measuring means for measuring fuel temperature within the fuel cell, a fuel storing means for storing the fuel supplied to the fuel cell, and a controlling means for controlling concentration of the fuel stored in the fuel storing means on the basis of fuel temperature measured with the measuring means after the steady state of the fuel cell is judged by the judging means.

One embodiment of the fuel cell device of the present invention comprises a water-level detecting means for detecting a remaining amount of fuel stored in the fuel storing means through water level, wherein the controlling means includes a concentration controlling means for controlling concentration of fuel stored in the fuel storing means on the basis of temperature difference between the fuel temperature measured with the measuring means and the adequate temperature of the fuel cell when the water level, detected with the water-level detecting means, is lower than the predetermined water level.

Moreover, the concentration controlling means in the fuel cell device of one embodiment of the present invention supplies a fuel concentration fuel to the fuel storing means when the fuel temperature measured with the measuring means is judged lower than the adequate temperature of the fuel cell and in also supplying a dilution liquid to the fuel storing means when the fuel temperature measured with the measuring means is judged higher than the adequate temperature of the fuel cell.

Moreover, the controlling means in the fuel cell device of one embodiment of the present comprises a fuel storing means for storing the fuel supplied to a fuel cell, and also a judging means for measuring an electrical power from the fuel cell when the fuel of fuel cell is circulated and judging the steady state of the fuel cell when the electrical power reaches the specified power, a measuring means for measuring fuel temperature in the fuel cell, a fuel storing means for storing the fuel supplied to the fuel cell, and a controlling means for controlling concentration of the fuel stored in the fuel storing means on the basis of the fuel temperature measured with the measuring means when the steady state of the fuel cell is judged with the judging means.

Moreover, a control program of a fuel cell device of one embodiment of the present invention controls a computer to execute a procedure for measuring an electrical power from the fuel cell when the fuel of the fuel cell is circulated, judges the steady state of the fuel cell when the electrical power reaches the specified power, and controls concentration of the fuel stored in a fuel storing means on the basis of the fuel temperature measured with a measuring means after the steady state is judged, by the measuring means for measuring fuel temperature in the fuel cell and the fuel storing means for storing the fuel supplied to the fuel cell.

The present invention can provide the following effects.

According to the fuel cell device of the present invention, there is provided a system for easily realizing stable supply of the fuel required for the fuel cell and economically operating the fuel cell always using the fuel in the optimum concentration by supplying a high concentration fuel and a dilution liquid to a fuel concentration management tank based on temperature change of the liquid fuel in the fuel cell under the steady state control of the fuel cell and by realizing also simplified control for a lesser number of monitoring points, through the monitoring of only temperature for controlling the fuel concentration to the reference level.

Moreover, in the steady state of the fuel cell, elements other than a temperature sensor and a water level sensor in some cases are not used. Therefore, sophisticated operations by a processor are no longer required because only a temperature sensor and a water-level sensor are monitored. As a result, all processes can be realized with only a low function, low price, and low power consumption processor. Namely, control configuration can be simplified. Accordingly, a fuel cell device which assures highly efficient stable operation can be realized.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram showing a fuel cell device of the present invention.

FIG. 2 shows a diagram of a conventional a fuel cell device.

FIG. 3 is a flowchart showing concentration control operation of a conventional fuel cell device.

FIG. 4 is a flow chart for showing concentration control operation of the fuel cell device of the present invention.

FIG. 5 is a diagram showing a structure of a temperature table.

FIG. 6 is a diagram showing a structure of a voltage table.

FIG. 7 is a diagram showing a structure of a current table.

FIG. 8 is a diagram showing a structure of a electrical power table.

FIG. 9 is a diagram showing a fuel cell device as a first embodiment when the fuel cell is activated.

FIG. 10A is an over-voltage protection circuit diagram of the fuel cell device as the first and second embodiments when the fuel cell is activated.

FIG. 10B is a diagram showing an example of the operation characteristics of the over-voltage protection circuit of FIG. 10A.

FIG. 11 is a load switching circuit diagram of the fuel cell device as the first and second embodiments when the fuel cell is activated.

FIG. 12A is a drive load circuit diagram of the fuel cell device as the first embodiment when the fuel cell is activated.

FIG. 12B is a diagram showing an example of characteristics of the drive load circuit of FIG. 12A.

FIG. 13 is a flow chart for showing an initial state of the fuel cell when the fuel cell is activated.

FIG. 14 is a flow chart of fuel cell activation process when an upper limit of voltage is varied when the fuel cell is activated.

FIG. 15 is a diagram showing an example of activation load control when the fuel cell is activated.

FIG. 16 is a flow chart of fuel cell activation process when an upper limit of current is varied while the fuel cell is activated.

FIG. 17 is a flow chart of fuel cell activation process when the current is varied compositely with voltage emphasized while the fuel cell is activated.

FIG. 18 is a flow chart of fuel cell activation process when the voltage is varied compositely with current emphasized while the fuel cell is activated.

FIG. 19 is a flow chart of fuel cell activation process when the current is varied compositely with voltage emphasized and a load increment timer is provided while the fuel cell is activated.

FIG. 20 is a diagram showing an example of change with time of voltage, current, and electrical power when the fuel cell is activated.

FIG. 21 is a diagram showing an output characteristic when activation process of fuel cell is detected or not detected.

FIG. 22 is a diagram showing a fuel cell device as the second embodiment when the fuel cell is activated.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

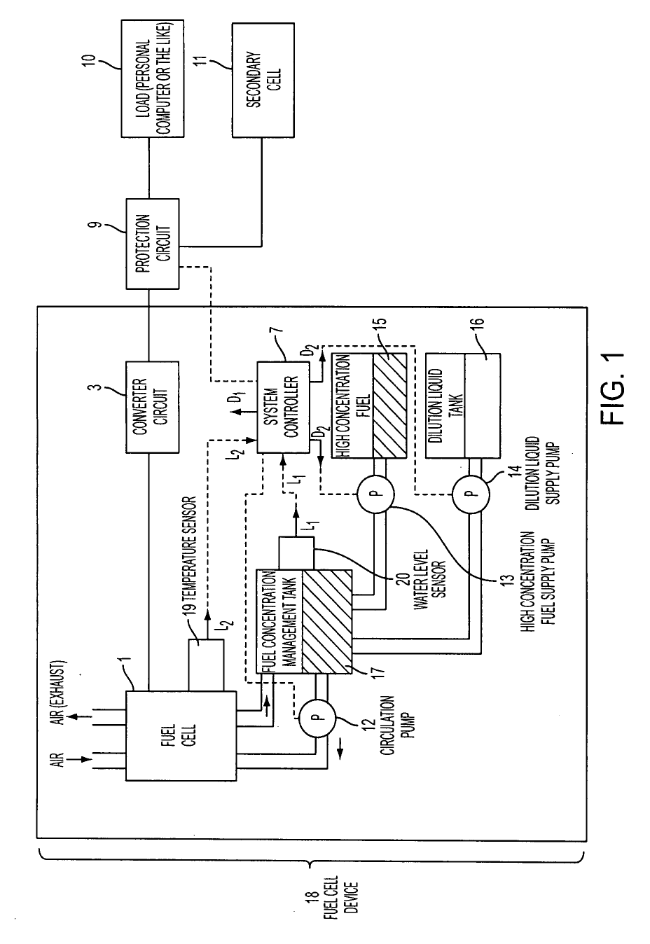

The first embodiment of the present invention will be explained by referring to FIG. 1. FIG. 1 is a diagram showing total system of a fuel cell device.

The fuel cell device 18 of the present invention comprises a fuel cell 1 for generating electrical power using a fuel. This fuel cell 1 is provided with an electrolyte film, an air pole, and a fuel pole. The air pole and fuel pole are arranged on either side of the electrolyte film. The air pole supplies air, including an oxygen element, to one surface side of the electrolyte film, while the fuel pole supplies a fuel, for example, a liquid fuel, including hydrogen element such as an aqueous solution of methanol, etc. to the other surface side of the electrolyte film. The electrolyte film is a transmitting film formed of a substance which can transmit protons or electrons. This transmitting film is constituted with a polymer electrolyte film such as a proton conductive solid-state polymer film, etc., formed of a substance of perfluorosulfonic acid. Therefore, the electrolytic film transmits hydrogen protrons from the liquid fuel on the fuel pole side, and the hydrogen proton is coupled with oxygen in the air supplied from the air pole side. As a result of this coupling, electrons remaining in the hydrogen within the liquid fuel are extracted as electricity to an external side of the fuel cell, and thereby this power generating operation functions as a cell.

In fuel cell 1, when methanol is used for the liquid fuel, water (vapor) is generated in the air pole side through reaction between hydrogen and oxygen via a proton catalyst of the electrolytic film, while carbon dioxide bubbles are generated in the fuel pole side through decomposition of methanol. For example, when power generation occurs through ideal chemical change through consumption of methanol of 1 mol and water of 1 mol in the fuel pole side and oxygen of 1 mol in the air pole side, water of about 3 mols is generated in the air pole side and carbon dioxide of about 1 mol is generated in the fuel pole side after such power generation.

The fuel cell 1 is coupled with a fuel concentration management tank 17 via an outgoing pipe and a return pipe and this return pipe is provided with a circulation pump 12. The fuel stored in the fuel concentration management tank 17 is circulated by driving circulation pump 12. Non-reacted fuel and carbon dioxide flow into the fuel concentration management tank 17 from the fuel pole in the fuel cell 1 via the outgoing pipe, the non-reacted fuel is mixed with the fuel within the fuel concentration management tank, and carbon dioxide is isolated from the non-reacted fuel and is guided into the liquid of the dilution liquid tank 16 by the drive, for example, of the dilution liquid supply pump 14 from the fuel concentration management tank 17.

The fuel concentration management tank 17 is coupled with the high concentration fuel tank 15 by a high concentration fuel supply pipe and also is connected with the dilution liquid tank 16 via the dilution liquid supply pipe. The high concentration fuel supply pipe is provided with a high concentration fuel supply pump 13, while the dilution liquid supply pipe is provided with a dilution liquid supply pump 14. A higher concentration liquid fuel, high concentration methanol, for example, is stored in the high concentration fuel tank 15. The high concentration liquid fuel in the high concentration fuel tank 15 is supplied to the fuel concentration management tank 17 by the high concentration fuel supply pump 13. Moreover, as the liquid in the dilution liquid tank 16, low concentration methanol and water, for example, are supplied to the fuel concentration management tank 17 by the drive of the dilution liquid supply pump 14. As a result, fuel of a managed concentration can be formed.

The fuel concentration management tank 17 is provided with a water-level sensor 20 for detecting water-level, while the fuel cell 1 is provided with a temperature sensor 19 for detecting temperature in the fuel cell 1.

The water-level sensor 20 generates a detection signal L1 by detecting the water-level of the fuel concentration management tank 17 and the temperature sensor generates a detection signal L2 by detecting temperature of fuel in the fuel cell 1. These detection signals L1, L2 are supplied to a system controller 7 as control information.

The system controller 7 receives the detection signals L1 and L2 and generates drive signals D1 and D2. The temperature sensor 19 is driven with the drive signal D1, while the high concentration fuel supply pump 13 and dilution liquid supply pump 14 are driven with the drive signal D2. Namely, the system controller 7 is formed of a microprocessor or the like and executes various controls such as fuel supply, concentration control of fuel and temperature control of fuel for the fuel cell 1 using a control program.

The system controller comprises judging means for judging a steady state of the fuel cell, measuring means for measuring fuel temperature in the fuel cell, and controlling means for controlling concentration of fuel.

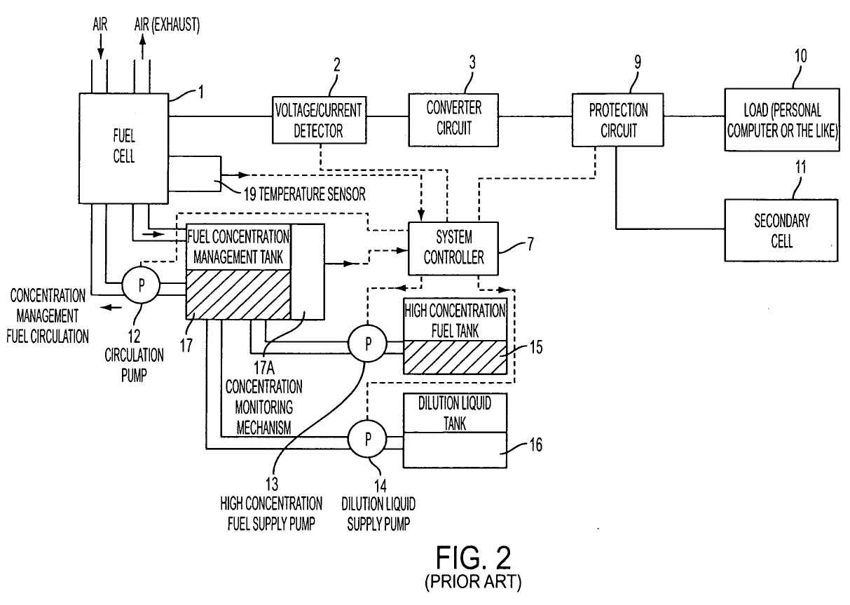

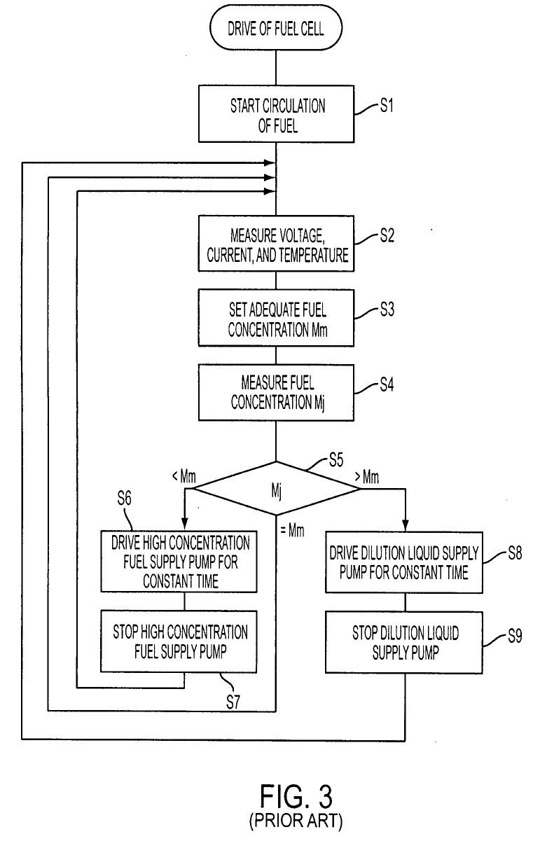

Concentration control operations of the fuel cell device of the prior art will be explained by referring to FIGS. 2 and 3. FIG. 3 is a flowchart showing control process in the related art which is executed by the system controller 7 of the fuel cell device of FIG. 2.

Upon reception of an operation instruction, the system controller 7 drives the fuel cell 1. Namely, the fuel is circulated for the fuel cell 1 (step S1).

With the fuel circulation process, the fuel under concentration management is circulated to the fuel cell 1 from the fuel concentration management tank 17 by the circulation pump 12.

When the fuel cell 1 is maintained in an operating condition, a voltage/current detector 2 measures voltage and current of the fuel cell 1 and the temperature sensor 19 measures temperature (step S2).

Voltage and current measured with the voltage/current detector 2 are used for recognizing a failure condition of the fuel cell 1 and temperature measured with the temperature sensor 19 is used for controlling fuel concentration Mj.

The fuel concentration management tank 17 is provided with a concentration monitoring mechanism 17A for monitoring fuel concentration Mj for circulating the fuel into the fuel cell 1. Moreover, adequate fuel concentration Mm is set in the system controller 7 (step S3).

The system controller 7 extracts the information of fuel concentration Mj of the fuel concentration management tank 17 monitored with the concentration monitoring mechanism 17A (step S4).

The system controller 7 compares the fuel concentration Mj monitored with the concentration monitoring mechanism 17A with the adequate concentration fuel Mm (step S5).

When fuel concentration Mj measured with the concentration monitoring mechanism 17A is lower than the adequate fuel concentration Mm, the system controller 7 drives the high concentration fuel supply pump 13 for a constant period (step S6).

When the high concentration fuel supply pump 13 is driven, the high concentration fuel is supplied to the fuel concentration management tank 17 from the high concentration fuel tank 15. After a constant period, the system controller 7 stops the high concentration fuel supply pump 13 (step S7) and the process returns to the step S2.

Voltage, current, and temperature of the fuel cell 1 are measured again.

When the fuel concentration Mj measured with the concentration monitoring mechanism 17A is the adequate fuel concentration Mm, it means that the normal fuel concentration control is conducted and the process returns to the step S2 without supply of the high concentration fuel and dilution liquid to the fuel concentration management tank 17. Voltage, current, and temperature of the fuel cell 1 are measured.

When the fuel concentration Mj measured with the concentration monitoring mechanism 17A is higher than the adequate fuel concentration Mn, the system controller 7 drives the dilution liquid supply pump 14 for a constant period (step S8). When the dilution liquid supply pump 14 is driven, the dilution liquid is supplied to the fuel concentration management tank 17 from the dilution liquid tank 16. After the constant period, the system controller 7 stops the dilution liquid supply pump 14 (step S9) and the process returns to the step S2.

Here, voltage, current, and temperature of the fuel cell 1 are measured again.

Operation of the fuel cell device is continued while repeating the control operations explained above.

An example of flowchart shows the case where a concentration sensor is provided in the fuel concentration management tank 17. In the case where the fuel cell device 18 mounts the concentration sensor, monitoring by sensor is always continued and operations explained above is conducted considering appearance of difference between the concentration obtained as a result of calculation and a calculation value by the concentration sensor as a key.

As an other prior art example, the operation in the case where the concentration sensor is not provided will be explained below. In this example, following processes are executed resulting from amount of the remaining fuel.

In a fuel cell state monitoring loop of the fuel cell device in the existing operation, monitoring by sensors of temperature, voltage, and current is necessary. Therefore, the total number of monitoring of the fuel cell sate monitoring loop is six, including water-level, temperature, voltage, current, calculation of power, and reference to a table for controlling concentration obtained by experiment.

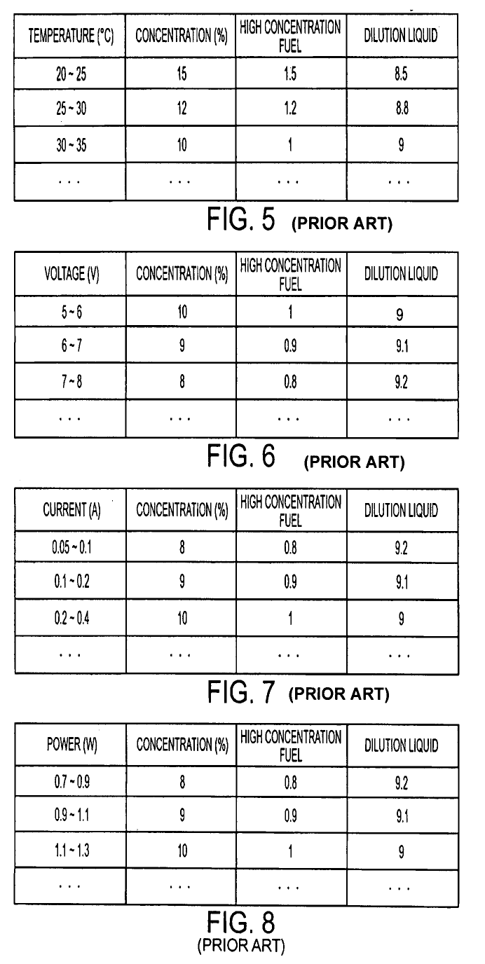

The table referred here is stored in the ROM of the system controller 7. This table includes a temperature table of FIG. 5, a voltage table of FIG. 6, a current table of FIG. 7, and a power table of FIG. 8.

The temperature table stores target concentration of the fuel concentration management tank and amount of supply of high concentration fuel and dilution liquid corresponding to temperature of the fuel cell 1.

The voltage table stores target concentration of the fuel concentration management tank, and amount of supply of the high concentration fuel and dilution liquid corresponding to voltage of the fuel cell 1.

The current table stores target concentration of the fuel concentration management tank and amount of supply of high concentration fuel and dilution liquid corresponding to current of the fuel cell 1.

The power table stores target concentration of the fuel concentration management tank and amount of supply of high concentration fuel and dilution liquid corresponding to power obtained from voltage and current of the fuel cell 1.

The system controller 7 sends an instruction as the information for amount of supply of high concentration fuel and dilution liquid to the high concentration fuel supply pump 13 and dilution liquid supply pump 14 on the basis of the amount of supply of the high concentration fuel and dilution liquid which is the information for concentration setting value obtained from these tables and each measuring value. The average of respective information pieces or weighted average by giving weight of importance is obtained from the temperature, voltage, current, power and a plurality of table information pieces and the amount of supply to be instructed to the high concentration fuel supply pump 13 and dilution liquid supply pump 14 is obtained on the basis of above result.

As an example of calculation of the arithmetic average, amount of supply of the high concentration fuel becomes as follows from each table under the condition that temperature is 28°, voltage is 5.8V, current is 0.21 A, power is 1.218 W. Namely, temperature is 1.2, voltage is 1, current is 1, power is 1.2, and average of these values becomes 1.05. Moreover, amount of supply of the dilution liquid becomes as follows. Namely, temperature is 8.8, voltage is 9, current is 9, power is 9 and the average value of these values becomes 8.95 from each table information.

Next, as the calculation example of the weighted average, by giving the weight of three times to the temperature, the amount of supply of the high concentration fuel becomes as follows under the condition that temperature is 28° C., voltage is 5.8V, current is 0.21 A and power is 1.218 W. Namely, temperature is 3.6 equal to three times of 1.2, voltage is 1, current is 1, power is 1 and the average value of these is 1.1 from each table information. It means (1.2×3+1+1+1)/6. Moreover, amount of supply of dilution liquid becomes as follows from each table information. Namely, temperature is 26.4 equal to three times of 8.8, voltage is 9, current is 9, power is 9 and the average value of these is 8.9. It means (8.8×3+9+9+9)/6.

As operations, instruction for adding of fuel is issued considering change in water-level of the water-level sensor of the fuel concentration management tank as the key.

From above explanation, the processes of six steps are required as the number of steps of the program for the control operations in the related art, except for the programs for pumping operations and suspending process for additional supply of fuel.

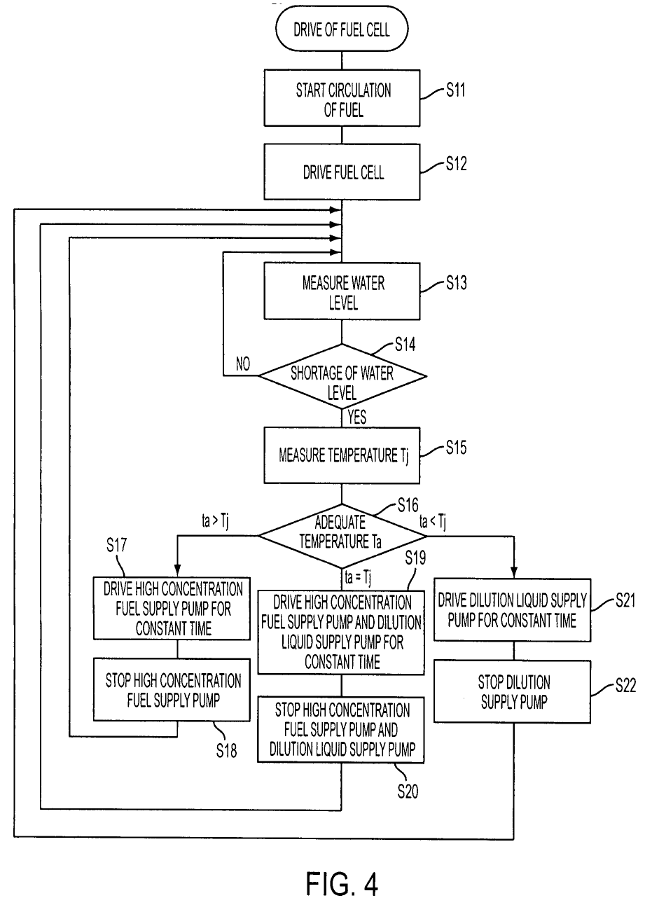

Concentration control operation of the fuel cell device of the present invention will be explained by referring to FIG. 4.

FIG. 4 is a flowchart showing the control processes of the present invention executed by the system controller 7 of the fuel cell device.

The elements having similar functions as those in the prior art are designated with the same reference numerals throughout the drawings.

Upon reception of an operating instruction, the system controller 7 drives the fuel cell device 1. Namely, the fuel is circulated for the fuel cell 11 (step S11).

When drive of the fuel cell 1 is initiated, the drive process of the fuel cell 1 is executed to attain a stable output of the fuel cell 1 (step S12).

Drive process of the fuel cell device will be explained later by referring to FIG. 4 to FIG. 21.

In the fuel concentration management tank 17, a water-level sensor 20 is provided to detect water level of the fuel to be circulated to the fuel cell 1. This water-level sensor 20 measures the water level (step S13).

When water level of the fuel concentration management tank 17 is sufficient (step S14), the process returns to the step S13 without supply of high concentration fuel and dilution liquid to continue measurement of water level of the fuel.

When the fuel cell 1 is connected with a load showing stable fuel consumption, since a water level reduction rate of the fuel concentration management tank is constant, measurement of water level of the fuel may be avoided.

When water level is measured to be insufficient (step S14) as a result of measurement of water level of the fuel with the water-level sensor 20, the temperature sensor 19 provided in the fuel cell 1 measures temperature Tj of the fuel cell 1 (step S15). Here, temperature detected by the temperature sensor 19 indicates temperature of the cells in the fuel cell 1. A plate type component, a separator provided among the cells of the fuel cell 1 for shielding fuel gas and air may be formed of carbon, for example, to assure excellent heat conductivity. Therefore, temperature of the electrolyte film and MEA (Membrane Electrode Assembly) which is the principal member for power generation of the fuel cell 1 held by the fuel pole and air pole with the electrolyte film held at the center can be estimated by measuring the temperature of cells.

As will be explained later, when an adequate process is executed for the fuel cell 1, fuel concentration can be can be controlled my managing the difference between the adequate temperature Ta and present temperature Tj of the fuel cell 1. Accordingly, calculating and setting the concentration for setting the adequate fuel concentration are no longer required.

The system controller 7 takes the information of present temperature Tj in the fuel cell 1 measured with the temperature sensor 19. Moreover, in this system controller 7, the adequate temperature Ta in the fuel cell 1 is also set.

The system controller 7 compares here the present temperature Tj measured with the temperature sensor 19 and the adequate temperature Ta set by the system controller 7 (step S16).

When the present temperature Tj measured with the temperature sensor 19 is lower than the adequate temperature Ta, the system controller 7 drives the high concentration fuel supply pump 13 for a constant period (step S17).

When the high concentration fuel supply pump 13 is driven, the high concentration fuel tank 15 supplies the high concentration fuel to the fuel concentration management tank 17. After the constant period, the system controller 7 stops the high concentration fuel supply pump (step S18). Here, the process returns to the step S13.

Moreover, when the present temperature Tj measured with the temperature sensor 19 is equal to the adequate temperature Ta, the system controller 7 drives the high concentration fuel supply pump 13, supplies the high concentration fuel to the fuel concentration management tank 17 from the high concentration fuel tank 15, drives the dilution liquid supply pump 14, and supplies the dilution liquid to the fuel concentration management tank 17 from the dilution liquid tank 16 for a constant time period (step S19).

After the constant period, the system controller 7 stops the high concentration fuel pump 13 and dilution liquid supply pump 14 (step S20). Here, the process returns to the step S13.

Moreover, when the present temperature measured with the temperature sensor 19 is higher than the adequate temperature Ta, it is considered as a result of occurrence of temperature rise because of generation of crossover phenomenon due to higher concentration of fuel. When concentration of methanol as the fuel is increased, methanol before decomposition passes through the electrolyte film resulting in easier generation of crossover phenomenon through direct reaction with oxygen without power generation.

When the present temperature Tj of the fuel cell 1 is higher than the adequate temperature Ta, the system controller 7 drives the dilution liquid supply pump 14 for a constant period (step S21).

When the dilution liquid supply pump 14 is driven, the dilution liquid is supplied to the fuel concentration management tank 17 from the dilution liquid tank 16. After the constant period, the system controller 7 stops the dilution liquid supply pump 14 (step S22). The process returns to the step S13.

Operations of the fuel cell device are continued through repetition of the control operations explained above and thereby temperature in the fuel cell can be controlled to the adequate temperature.

In the fuel cell state monitoring loop of the fuel cell device in the operations of the present invention, it is not required to conduct monitoring by sensors for temperature, voltage, and current or the like. Therefore, the total number of monitoring elements in the fuel cell state monitoring loop is three steps of monitoring of water level, temperature and reference to the table for obtaining amount of supply of high concentration fuel or dilution liquid, depending on temperature with the experiment and for controlling the concentration based on the result of experiment.

The table referred here is stored in the ROM within the system controller 7. The temperature table stores, corresponding to temperature of the fuel cell 1, concentration of the fuel concentration management tank and amount of supply of the high concentration fuel and dilution liquid. The system controller 7 further sends an instruction as the information for amount of supply of the high concentration fuel and dilution liquid to the high concentration fuel supply pump 13 and dilution liquid supply pump 14 on the basis of the amount of supply of high concentration fuel and dilution liquid as the information of concentration setting value obtained from the table and each measured value.

As the operation, additional supply of fuel is instructed considering a change in water level as the key.

In the control operation in the present invention, only three steps are required, from the above explanation, as the number of steps in the program in the control operation of the present invention, except for the program for pump operation and stop a process for addition of fuel.

In order to recognize the steady state, it is necessary to monitor voltage and current of the fuel cell and to recognize that the present state is enough for outputting the specified power. However, since the process after steady state of the fuel cell 1 is only the monitoring with temperature sensor and water-level sensor, highly sophisticated processor processes are not required.

As a result, performing processes by a lower function and lower priced processor can be realized.

Moreover, when power consumption of the system controller 7 of the fuel cell device 18 during the standby state can be assumed as almost zero, a power consumption rate in the monitoring loop depends on the number program steps in the monitoring loop.

In the case of monitoring only by temperature sensor, processes of three steps are executed as explained above and in the case of the total monitoring, such as monitoring of temperature, voltage, and current, the processes of six steps are conducted. Therefore, the power consumption in the present invention can be lowered by about a half (½).

In regard to power consumption, operations of the system controller 7 in the monitoring loop are constituted with sensor input (A/D converter), monitoring process, and standby operation. Usually, while a sensor value is measured with an A/D converter, the standby process is often specified for reduction of operation noise of a microprocessor.

Relationship between the actual operation per constant period of the fuel cell device and standby operation indicates (1) preparations for measurement by the A/D converter and temperature measurement by temperature sensor, (2) extraction of information through measurement by sensor, (3) step process in the monitoring control, and (4) standby of microprocessor including preparations for measurement by A/D converter and sensor. The processes from (1) to (4) are repeated.

The standby period can be extended by setting a longer data extraction interval and thereby power consumption per second can also be reduced. Therefore, power consumption can further reduced from about ½.

Moreover, in the pre-stage of preparation for measurement by the A/D converter and sensor, water level of the fuel concentration management tank 17 is measured with the water-level sensor 11. When there is no change in water level, operations from (1) to (3) are not executed and the microprocessor in (4) is set to the standby state. In this case, power consumption is further lowered from that in the case where the processes of (1) to (4) are repeated.

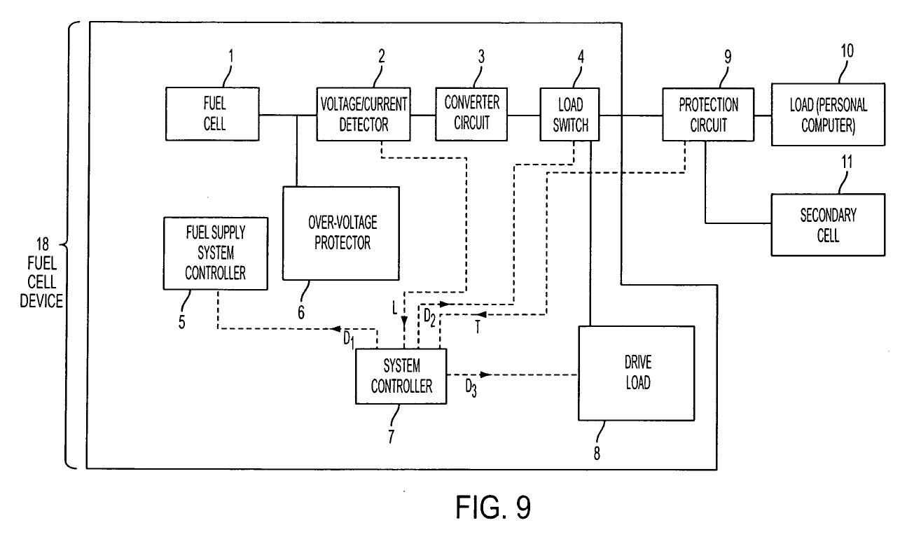

A drive process of the fuel cell device, which is the precondition of the control of the steady state in the present invention, will be explained by referring to FIG. 9 to FIG. 11.

### First Embodiment of Drive Process

A first embodiment of the drive process will be explained by referring to FIG. 9. FIG. 9 shows the entire system of a fuel cell device of the first embodiment when the fuel cell is driven. The structure required for control in the steady state, explained above, is partly omitted.

In FIG. 9, the reference numeral 1 designates a fuel cell; 2, a voltage/current detector; 3, a converter circuit; 4, a load switch circuit, 5 a fuel supply system controller; 6, an over-voltage protector; 7, a system controller; 8, a driving load; 9, a protection circuit; 10, a steady load such as a personal computer; 11, a secondary cell; and 18, a fuel cell device.

The fuel cell 1 is connected with the voltage/current detector 2 for detecting output voltage and output current of the relevant fuel cell, while the voltage/current detector 2 with the converter circuit 3, the converter circuit with the load switch circuit 4, the load switch circuit with the protection circuit 9, and the protection circuit 9 with the load 10 such as personal computer and the secondary cell 11.

Moreover, when the fuel is initially supplied to the fuel cell 1 and an output voltage of the fuel cell 1 rises, the over-voltage protector 6 is connected between the fuel cell 1 and voltage/current detector 2 in order to restrict an output voltage of the fuel cell. Moreover, the drive load unit 8 having a higher internal resistance is connected in parallel in the load switch circuit 4.

When the fuel cell 1 is driven, the voltage/current detector 2 for detecting output voltage and output current of the fuel cell generates the detection signal L by detecting voltage and current of the fuel cell 1. The detection signal L is inputted to the system controller 7 as the control information. The system controller 7 receives this detection signal L and generates the drive signals D1, D2, and D3. The fuel supply system controller 5 controls supply of the fuel to the fuel cell and initiates supply of fuel to the fuel cell by receiving the drive signal D1. The load switch circuit 4 switches the load to which the output voltage and current of the fuel cell flow to any of the drive load located in the drive load unit 8 and the load 10 such as a personal computer and realizes the switching of load by receiving the drive signal D2. The drive load unit 8 increases the load with variable voltage or current depending on the constant rate and increases the load of drive load by receiving the drive signal D3.

Moreover, with a load such as sudden power generation of the fuel cell 1 or sudden stop of operation, the load 10 such as a personal computer is influenced by voltage drop and surge voltage. In order to prevent a failure of power supply circuit and mother board of the personal computer due to the influence explained above, the protection circuit 9 generates a stop signal T and this stop signal T is applied to the system controller 7 as the control information.

The system controller 7 is formed of a microprocessor or the like and also executes supply of fuel to the fuel cell 1, stop of supply of fuel, and load control thereof with the control program as explained above.

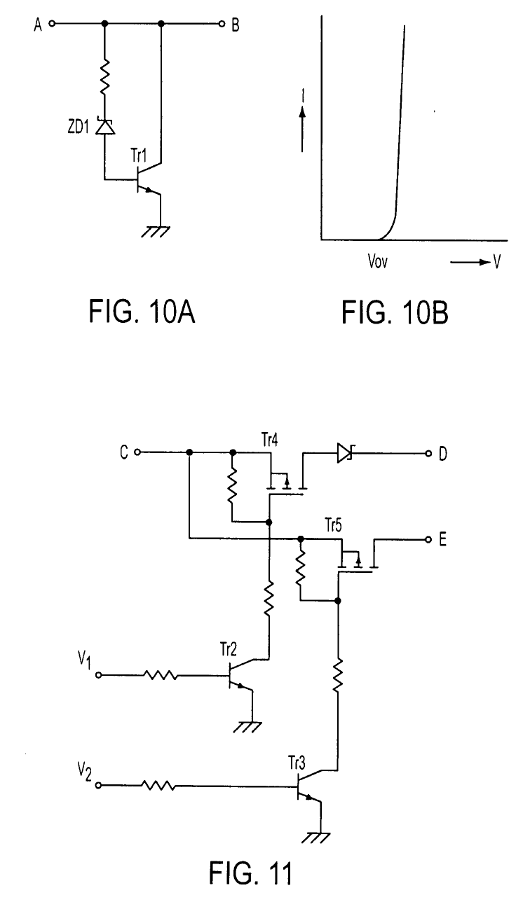

FIG. 10A is a diagram showing an example of the over-voltage protection circuit of the fuel cell device as the first and second embodiments when the fuel cell is driven.

A protection threshold voltage Vov is equal to sum of a zener voltage Vzd1 of a zener diode ZD1 and a forward voltage VbeTr1 between the base and emitter as the electrodes of a transistor Tr1. Namely, the protection threshold voltage Vov is defined as Vzd1+VbeTr1.

When the zener diode is loaded with an inverse voltage which is lower than the setting voltage Vzd1, no current flows into the diode, and when the inverse voltage which is higher than the setting voltage is applied, the diode suddenly allows flow of current. The transistor includes three terminals, namely, the base, emitter, and collector. A heavy current between the collector and emitter can be controlled to ON and OFF by making ON and OFF a minute current between the base and emitter, thereby resulting in the switching operation. As an example where these elements are applied to the over-voltage protection circuit, a circuit as shown in FIG. 10A is constituted. The point A of the over-voltage protection circuit is connected to the fuel cell 1, while the point B is connected to the voltage/current detector 2. A power line between A and B in FIG. 10A is identical to the line between the fuel cell 1 and the voltage/current detector 2 in FIG. 9. Operations of the over-voltage protection circuit of the over-voltage protector 6 will be explained below, the operation of which can be seen in FIG. 10B. When an input voltage Va of the fuel cell 1 is lower than Vov (Va<Vov), namely when an inverse voltage of the zener diode is lower than the setting voltage, a current does not flow between the base and emitter, and therefore the transistor is in the OFF state and no current flows into the over-voltage protection circuit. Meanwhile, the input voltage Va rises, exceeding Vov, and a current starts to flow into the zener diode. Therefore, a base current Ib flows across the base and emitter of the transistor and thereby the transistor enters the ON state.

When the current Ib flows across the base and emitter, a collector current Ic also flows across the collector and emitter. In the transistor, the base current Ib is hFE-folded to become a collector current Ic. A proportional constant hFE is called the DC current amplification factor and a value of hFE is selected to about 10 to 1000 times. Usually, many kinds of this transistor are manufactured for the target of the value of hFE as about 100.

Under the condition that the collector current Ic occupies a greater part for the base current Ib and a large amount of current flows as the collector current Ic, an impedance of the over-voltage protection circuit becomes almost zero and therefore an output voltage Vb can no longer rise from the preset value.

With operations of the over-voltage protection circuit as explained above, the output voltage Vb is always kept within Vov.

FIG. 11 shows an example of the load switch circuit in a load limiting circuit 14 of the fuel cell device as the first and second embodiments when the fuel cell is driven

When the voltage V1 and voltage V2 in the figure are set to a low voltage, no current flows in to the circuit, providing no output from the fuel cell.

When the voltage V1 is set to a low voltage, while the voltage V2 is set to a high voltage, the current outputted from the fuel cell also flows into the drive load in the drive load unit 8.

Moreover, when the voltage V1 is set to a high voltage and the voltage V2 to a low voltage, the current outputted from the fuel cell flows into the personal computer or a secondary cell.

Here, it is desirable that an inflow preventing diode is provided in the circuit where a current flows into the personal computer or secondary cell in view of preventing inflow of the current to the fuel cell side. In such load switch circuit, an output of fuel cell is switched to the drive load side and personal computer or secondary cell side and thereby the fuel cell device is controlled.

The point C of the load switch circuit is connected to the side for receiving an output of the fuel cell 1, the point D is connected to the load 10 such as personal computer or the like, and the point E is connected to the drive load in the drive load unit 8. Moreover, V1 and V2 are connected to the system controller 7. This system controller 7 generates drive signal D2 for setting the voltages V1 and V2 and the load switch unit 4 receives the drive signal D2 for switching of load.

The power line between C and D in FIG. 11 is identical to the line between the converter circuit 3 and the protection circuit 9 in FIG. 9.

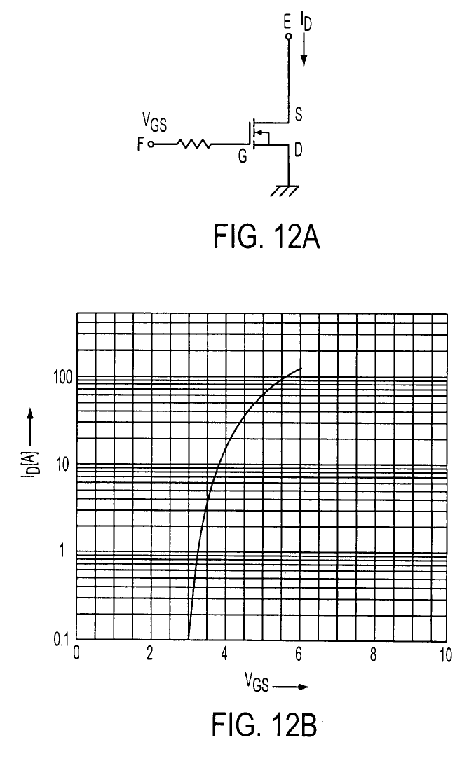

FIG. 12A is a diagram showing an example of the drive load circuit in the drive load unit 8 of the fuel cell device of the first embodiment when the fuel cell is driven. This circuit is formed of a field effect transistor (FET).

This FET has three terminals and the three portions forming this FET are named as source (S), gate (G) and drain (D). When a gate voltage Vgs with reference to the source (S) rises, the current Id flowing into the drain (D) from the source (S) rises dramatically as seen in FIG. 12B.

When a field effect transistor (FET) is applied to the drive load circuit, the system controller generates the drive signal D3 and the drive load unit 8 receives the drive signal D3 in order to control a voltage Vgs.

Namely, when the fuel drive 1 is driven, the drive load unit 8 receives the drive signal D3 for setting the voltage Vgs to the value higher than the threshold value from the system controller 7. When the voltage Vgs rises, the current Id flows into the drive load circuit side. The voltage Vgs rises step by step in order to increase the current Id.

Meanwhile, when drive of fuel cell 1 is completed and the fuel cell 1 transfers to the steady state, the drive load unit 8 receives the drive signal D3 for setting the voltage Vgs to a value lower than the threshold value from the system controller 7. Since the voltage Vgs becomes lower than the threshold value, the current Id does not flow into the drive load circuit side.

The graph, as shown in FIG. 12B shows the typical transfer characteristic by plotting the current Id on the vertical axis and the voltage Vgs on the horizontal axis.

The point E of the drive load circuit is connected to the point E of the load switch circuit, while the point F is connected to the system controller 7. Namely, the drive signal D3 generated from the system controller 7 is connected to the point F of the drive load circuit.

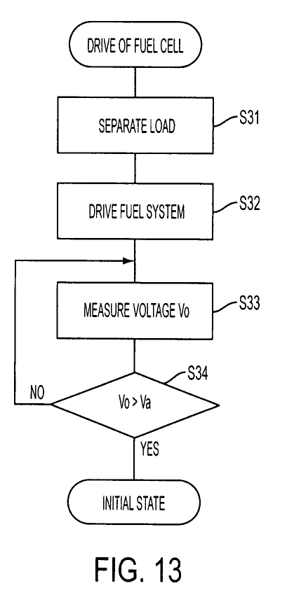

FIG. 13 is a flowchart for explaining operations of the system controller 7 in the system configuration of FIG. 9 for recognizing an initial state of the fuel cell 1.

Next, operations of the system controller 7 in the system of FIG. 9 will be explained by referring to FIG. 13. First, upon reception of an operating instruction, the system controller 7 corresponding to the controller generates the drive signal D2 to isolate the load at the time of drive and the load switch 4 separates both loads of the drive load 8 and the load 10 such as a personal computer (step S31). Since the voltages V1 and V2 of the load switch circuit (FIG. 11) are set to lower values by the drive signal D2, both drive load 8 and the load 10 are separated.

Since the system controller 7 supplies the fuel to the fuel cell after separation of loads, the drive signal D1 is outputted to the fuel supply system controller and the fuel supply system controller 5, having received the drive signal D1, drives the fuel system and supplies the fuel and oxygen to the fuel cell (step S32).

When the fuel and the oxygen are fully circulated into the fuel cell, the fuel cell 1 generates electrical power. Power generation by the fuel cell 1 is conducted under the non-load state without connection to the load. The voltage/current detector 2 always detects voltage and current of the fuel cell and the system controller 7 receives the non-load voltage Vo of the fuel cell 1 read by the voltage/current detector 2 (step S33).

The system controller 7 determines whether the non-load voltage Vo of the fuel cell 1 transmitted from the voltage/current detector 2, has raised up to the voltage initial value Va as the limiting voltage or not (step S34). Namely, whether or not the fuel is fully circulated into the fuel cell 1 is determined.

When the non-load voltage Vo of the fuel cell 1 is lower than the voltage initial value Va, the process returns to the step S33. The system controller 7 continues reception of the non-load voltage Vo of the fuel cell 1 read by the voltage/current detector 2. In addition, when the non-load voltage Vo of the fuel cell is higher than the voltage initial value Va, the system controller 7 determines that the fuel cell 1 is in the initial state. Namely, the system controller 7 determines that the fuel cell is in the state that it is sufficiently filled with the fuel.

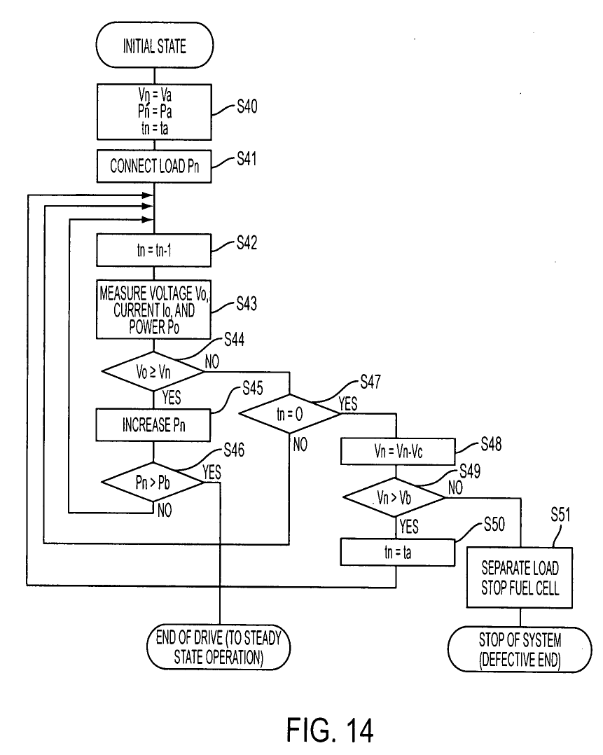

FIG. 14 is a flowchart for explaining operations in the system configuration of FIG. 9 until the fuel cell 1 transfers to the steady state from the initial state thereof after completion of control at the time of drive. In this flowchart, control operation is executed with reference to voltage.

Next, the fuel cell drive process within the system configuration of FIG. 9 will be explained by referring to FIG. 14.

When it is determined that the fuel cell 1 is in the initial state, the system controller 7 sets the load power consumption value Pn′ to the load power consumption initial value Pa from voltage initial value Va×current initial value Ia by setting the voltage Vn to the voltage initial value Va and the current In to the current initial value Ia and also sets the specified number of times of repletion ta of the present number of times of repetition tn (step S40).

The system controller 7 generates the drive signal D2 for the load switch unit 4 and the load switch circuit 4 receives the drive signal D2 to connect the load connected to the drive load Pn in which resistance can be varied (step S41).

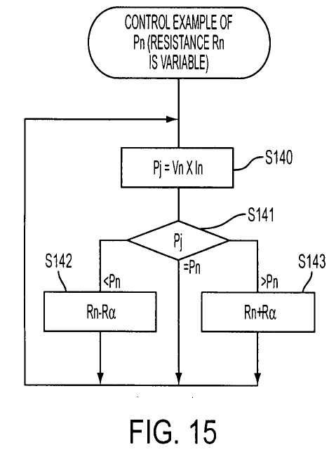

In the circuit operation where the load switch unit 4 connects the load to the drive load Pn where resistance is varied, when the voltage V1 is set to a low voltage and the voltage V2 is set to a high voltage as explained by referring to FIG. 11, the current outputted from the fuel cell 1 flows into the drive load Pn in the drive load unit 8. Moreover, control of the drive load Pn where resistance is varied will be explained by referring to FIG. 15.

The system controller 7 measures the present number of times of repetition tn (step S42).

The voltage/current detector 2 measures voltage Vo and current Io and calculates power Po as voltage Vo×current Io (step S43).

The measured voltage Vo is inputted to the system controller 7 as the sense signal. The system controller 7 determined whether the voltage Vo is equal to or higher than the setting value Vn, here equal to or higher than the voltage initial value Va (step S44).

When the voltage Vo is equal to or higher than the setting value Vn, the system controller 7 generates, for the drive load unit 8, the drive signal D3 for increasing step by step the drive load Pn, and the drive load unit 8 receives the drive signal D3 to increase step by step the drive load Pn (step S45).

In regard to the drive load Pn, the drive load unit 8 controls the drive load Pn to a constant value in FIG. 12A by varying an internal resistance Rn of the field effect transistor (FET), namely in the drive load Pn. Here, the drive load Pn of the drive load unit 8 can be increased step by step depending on the case where the system controller 7 varies amount of change with a numerical map or with an input. The system controller 7 generates the drive signal D3 for the drive load unit 8 and the drive load unit 8, having received the drive signal D3, varies the drive load Pn as much as amount of change. The drive load Pn having increased as much as amount of change is maintained in the constant value with the control of FIG. 15.

As explained above, voltage control can be realized without sudden change in the fuel cell body under the condition that the fuel cell 1 is driven from the initial state thereof by increasing, step by step, the drive load Pn.

Moreover, since the drive load Pn is increased, step by step, during measurement of the voltage Vo, stable load operation can be realized and the fuel cell drive having higher reliability can also be realized.

Moreover, because of step-by-step change, amount of heavy current in load change for every timing for variation of each drive load can be detected easily and familiarization time of fuel can be assumed. Therefore, the familiarization time can be set in optimum for each timing of drive load and it is no longer required to change the load by taking unnecessary longer time.

The system controller 7 previously sets the upper limit value Pb at the time of drive of the power consumption in the load for the drive load Pn.

The system controller 7 determines whether the drive load Pn has raised or not up to the upper limit value Pb at the time of drive (step S46).

When the system controller 7 has determined that the drive load Pn is lower than the upper limit value Pb at the time of drive, the process returns to the step S42 for continuation of drive.

The voltage/current detector 2 continues measurement of voltage Vo, current Io, and power Po until the constant time has passed and the measured values are then inputted to the system controller 7 as the sense signals.

Moreover, the system controller 7 generates, upon determination that the drive load Pn is higher than the upper limit value Pb at the time of drive, the drive signal D2 for the load switch unit 4 in order to suspend control at the time of drive of the fuel cell. The load switch unit 4 receives the drive signal D2, switches the load to the load 10, such as a personal computer, from the drive load of the drive load unit 8 to transfer the state of system to the steady state.

The route up to the step S46 from the step S42 is taken when the voltage Vo rises up to the voltage initial value Va.

Moreover, the system controller 7, having received the measured value measured by the voltage/current detector 2 with the sense signal, determines whether voltage Vo is equal to or higher than the setting value Vn, here the voltage initial value Va or not. When the voltage Vo is lower than the setting value Va, whether or not the present number of times of repetition tn is 0 is determined (step S47).

When tn is not equal to 0, the process returns to the step S42. Until constant time has passed, the voltage/current detector 2 continuously measures voltage Vo, current Io, and power Po and the measured values are inputted to the system controller 7 as the sense signal.

When the voltage Vo is equal to or lower than the voltage initial value Va in the steps from 42 to 44, the route to return to the step S42 passing the step S47 is taken in the case where the voltage Vo does not rise up to the voltage initial value Va while the present number of times of repetition tn is within the specified number of times of repetition ta.

Moreover, when tn is equal to 0 in the step S47, since the voltage Vo does not rise up to the voltage initial value Va while the present number of times of repetition tn is within the specified number of times of repetition ta, the setting value Vn is reduced as much as amount of change Vc and becomes equal to setting value Vn−voltage change Vc and this value is defined as the setting value Vn (step S48).

The system controller 7 presets the voltage lower limit Vb for the setting value Vn of voltage. The voltage/current detector 2 receives the sense signal of the setting value Vn to determine whether the setting value Vn is equal to or higher than the voltage lower limit value Vb (step S49).

As explained above, the voltage is lowered up to the voltage lower limit value Vb which is allowed as the lower limit value of voltage by reducing step by step the changing amount of voltage Vc from the voltage initial value Va of the fuel cell 1.

In the step S49, the system controller 7 sets again, upon determination that the setting value Vn is higher than the voltage lower limit value Vb, the present number of times of repetition tn to the specified number of times of repetition ta. The setting value Vn is changed to the value equal to setting value Vn−amount of voltage change Vc and this voltage value becomes the new initial value. Here, the process returns to the step S42.

The system controller 7 having received the measured value measured with the voltage/current detector 2 with the sense signal determines whether the voltage Vo is equal to or higher than the setting value Vn which has been set as the new initial value, here the value equal to setting value Vn−amount of voltage change Vc.

When the voltage Vo is lower than the setting value Vn which has been set as the new initial value, the processes are executed taking the route of steps from S44 to S47 and the steps from S47 to S50. In this case, the voltage is reduced again as much as amount of voltage change Vc from the setting value Vn, determination is conducted in the step S44 using the value of setting value Vn after reduction of the amount of voltage change Vc, and processes are executed by taking the route from the step S44 to the step S46.

Moreover, the system controller 7 receives the sensor signal of the setting value Vn measured by the voltage/current detector 2 and likely reduces the setting value Vn up to the voltage lower limit value Vb in the step S49. However, when the setting value Vn is determined to be lower than the voltage lower limit value Vb, it suggests that the fuel cell 1 is defective or the fuel cell 1 is in the irregular state where the fuel is already supplied and voltage does not rise.

Therefore, the system controller 7 generates the drive signal D2 for the load switch unit 4 aiming at stoppage of the fuel cell and the load switch unit 4 receives the drive signal D2 and isolates the drive load of the connected load switch unit 8.

In view of conducting the fuel cell suspending process (step S51), the system controller 7 generates the drive signal D1 to the fuel supply system controller 5 and this fuel supply system controller 5 receives the drive signal D1 and executes the termination process such as the process to exhaust the fuel in the fuel cell.

FIG. 15 is a flowchart showing an example of control of a variable resistance Rn of the drive load Pn in the drive load unit 8 when the fuel cell is driven. As a resistance body, a static element such as a transistor or a load of switching element may be used.

Here, a field effect transistor (FET) in FIG. 12A is considered as an example and the drive load Pn is controlled to the constant value by varying an internal resistance Rn of the field effect transistor.

Next, internal operations of the drive load unit 8 in the system of FIG. 9 will be explained by referring to FIG. 15. First, upon reception of an operating instruction, the system controller 7 corresponding to the controller generates the sense signal for driving the fuel cell 1 to the fuel cell 1. The voltage/current detector 2 measures voltage Vn as the voltage information of a battery from the fuel cell 1 and current In as the current information and calculates power Pj with Vn×In (step S140). Namely, the drive load Pn is controlled by measuring power Pj.

The system controller 7 having received the power information from the voltage/current detector 2 compares the calculated power Pj with the power consumption initial value Pn as the drive load Pn (step S141).

The system controller 7 generates, upon determination that the calculated power Pj is lower than the power consumption initial value Pn, the drive signal D3 to the drive load unit 8. The drive load unit 8 receives the drive signal D3 and subtracts adequate resistance value Rα from the variable resistance Rn of the drive load Pn (step S142). Therefore, resistance is reduced, the current In flowing into the drive load increases in order to increase the calculated power Pj which is closing to the power consumption initial value Pn.

Moreover, the system controller 7 does not generate, when the calculated power Pj is determined to be equal to the power consumption initial value Pn, the drive signal for the drive load unit 8 and therefore the variable resistance Rn in the drive load Pn is maintained as it is.

The system controller 7 generates, when the calculated power Pj is determined to be higher than the power consumption initial value Pn, the drive signal D3 for the drive load unit 8. The drive load unit 8 receives the drive signal D3 and adds the adequate resistance value Rα to the variable resistance Rn of the drive load Pn (step S143). Therefore, resistance increases and the current In flowing into the drive load is reduced. Thereby, the calculated power Pj is reduced to become close to the power consumption initial value Pn.

When the drive process of fuel cell 1 is conducted by repeating the control operation of the drive load Pn of the drive load unit 8 when the fuel cell is driven, the processes are conducted to vary the internal resistance Rn and to make constant the power consumption initial value Pn as the drive load Pn for each timing.

Moreover, the drive load Pn can be increased step by step by varying amount of change utilizing numerical map indicating a load variable ratio with the system controller 7 and by varying amount of change with direct input.

Numerical values in the numerical map indicating the load variable ratio are provided to make small the amount of increase of load when the fuel cell is driven initially, or to make comparatively large the amount of increase of load in the intermediate stage, or to make small again the amount of increase of load at the value near the upper limit value Pb at the time of drive in the load power consumption. Numerical values of the numerical map can always be updated in accordance with the state of fuel cell in order to realize that the fuel cell can be set to the steady state within the shortest period by utilizing the numerical map.

The system controller 7 generates the drive signal D3 to the drive load unit 8 and the drive load unit 8 having received the drive signal D3 varies the drive load Pn as much as amount of change. The drive load Pn having increased as much as mount of change is maintained to constant value under the control in FIG. 15.

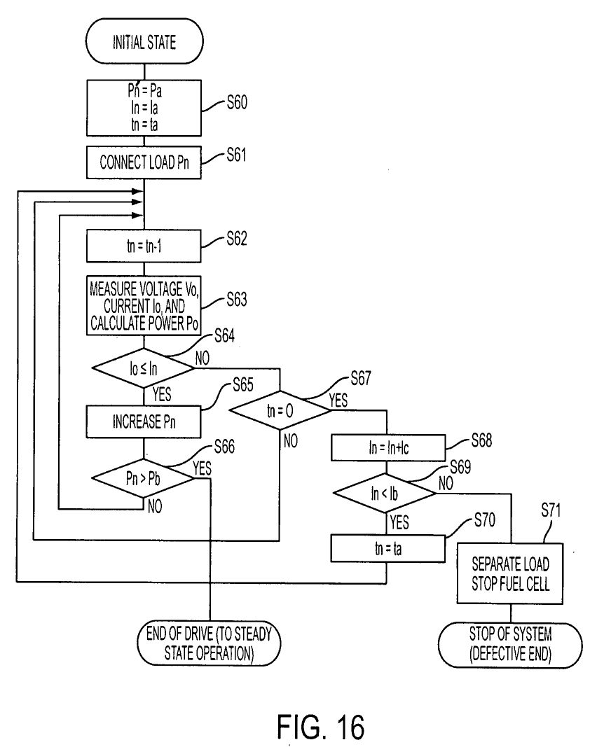

FIG. 16 is a flowchart for explaining operations in the system configuration of FIG. 9 up to transfer to the steady state of fuel cell 1 from the initial state thereof after completion of control at the time of drive. Here, control is executed with reference to current.

Next, a fuel cell drive process in the system configuration of the system of FIG. 9 will be explained by referring to FIG. 16.

Upon determination that the fuel cell 1 is in the initial state, the system controller 7 sets the load power consumption value Pn′ to the load power consumption initial value Pa from current initial value Ia×voltage initial value Va by setting the current In to the current initial value Ia and the voltage Vn to the voltage initial value Va and also sets the specified number of times of repetition ta of the present number of times of repetition tn (step S60).

The system controller 7 generates the drive signal D2 to the load switch unit 4 the load switch unit 4 receives the drive signal D2 and connects the load connected to the drive load Pn having variable resistance (step S61). In the circuit operation where the load switch unit 4 connects the load to the drive load Pn having the variable resistance, when the voltage V1 is set to a low voltage and the voltage V2 to a high voltage as explained by referring to FIG. 11, an output current of the fuel cell 1 flows into the drive load Pn of the drive load unit 8.

The system controller 7 measures the present number of times of repetition tn (step S62).

The voltage/current detector 2 calculates power Po with voltage Vo×current Io by measuring voltage Vo and current Io (step S63).

The measured current Io is inputted to the system controller 7 as the sense signal. The system controller 7 determines whether the current Io is equal to or lower than the setting value In, here the current initial value Ia (step S64).

When the current Io is equal to or lower than the setting value In, the system controller 7 generates the drive signal D3 to the drive load unit 8 to increase step by step the drive load Pn and the drive load unit 8 receives the drive signal D3 and increases the drive load Pn step by step (step S65).

The drive load Pn can be controlled to a constant value by varying an internal resistance Rn of the field effect transistor (FET) with the drive load unit 8 of FIG. 12A, namely of the drive load Pn. Here, the drive load Pn of the drive load unit 8 can be increased step by step by varying amount of change of numerical map with the system controller 7 or by varying amount of change with an input. The system controller 7 generates the drive signal D3 to the drive load unit 8 and the drive load unit 8 having received the drive signal D3 varies the drive load Pn as much as amount of change. The drive load Pn having increased as much as amount of change is maintained in the constant value under the control of FIG. 15.

As explained above, voltage control can be realized without giving sudden change of the fuel cell body while the fuel cell 1 is transferred to the drive time from the initial state by increasing step by step the drive load Pn.

Moreover, since the drive load Pn increases step by step while the current Io is measured, highly reliable fuel cell device which can realize stable load operation can be obtained.

Moreover, because of step-by-step change, amount of heavy current in change of load in every variation timing of each drive load can be easily detected and the familiarization time of fuel can also be assumed.

Next, the system controller 7 previously sets the upper limit value Pb at the time of drive of the load power consumption for the drive load Pn.

The system controller 7 determines whether the drive load Pn has increased up to the upper limit value Pb at the time of drive (step S66).

When the system controller 7 has determined that the drive load Pn is lower then the upper limit value Pb at the time of drive, the process returns to the step S62 for continuation of drive.

Until constant time has passed, the voltage/current detector 2 continuously measures voltage Vo, current Io, and power Po and the measured values are inputted to the system controller 7 as the sense signal.

Moreover, upon determination that the drive load Pn is higher than the upper limit value Pb at the time of drive, the system controller 7 generate the drive signal D2 to the load switch unit 4 in order to terminal control at the time of drive of the fuel cell, and the load switch unit 4 receives the drive signal, switches the load connected to the load 10 such as personal computer from the drive load of the drive load unit 8, and then transfers the state of system to the steady state.

The route to step S66 from step S62 is taken when the current Io does not rises up to the current initial value Ia.

Moreover, the system controller 7 having received the values measured by the voltage/current detector 2 with the sense signal determines whether the current Io is equal to or higher than the setting value In, here the current initial value Ia. When the current Io is higher than the setting value In, whether the present number of times of repetition tn is equal to 0 is determined (step S67).

When tn is not equal to 0, the process returns to the step S62. The voltage/current detector 2 continues measurement of voltage Vo, current Io, and power Po until the constant time has passed and the measured values are inputted to the system controller 7 as the sense signal.

When he current Io is equal to or higher than the current initial value Ia in the steps from the step 62 to the step 64, the route to return to the step S62 passing the step S67 is taken when the current Io rises up to the current initial value Ia while the present number of times of repetition tn is within the specified number of times of repetition ta.

Moreover, when tn is equal to 0 in the step S67, the current Io rises up to the current initial value Ia while the present number of times of repetition tn is within the specified number of times of repetition ta. Therefore, the setting value In is increased as much as amount of change Ic of current and thereby it becomes equal to the value of setting value In+amount of change of current Ic. This value is then defined as the setting value In (step S68).

The system controller 7 presets the current upper limit value Ib for the setting value of current In. The system controller 7 receives the sense signal of the setting value In measured by the voltage/current detector 2 and determines whether the setting value In is equal to or lower than the current upper limit value Ib (step S69).

The current is increased up to the current upper limit value Ib which is allowed as the upper limit of the current by increasing little by little the amount of change of current Ic from the current initial value Ib of the fuel cell 1.

The system controller 7 sets again, upon determination that the setting value In is lower than the current upper limit value Ib, the present number of times of repetition tn to the specified number of times of repetition ta in the step S69. The setting value In is changed to the setting value In +amount of change of current Ic. This value is set as the new initial value. Here, the process returns to the step S62.

The system controller 7 having received the value measured with the voltage/current detector 2 with the sense signal determines whether the current Io is equal to or lower than the setting value In which has been set as the new initial value.

When the current Io is higher than the setting value In which has been set as the new initial value, the processes are conducted by taking the route from the step S64 to the step S67 and the route from the step S67 to the step S70. However, in this case, amount of change of current Ic is added again to the setting value In, determination is made in the step S64 using the value of the setting value In which has been increased by the amount of change of current, and the processes are executed taking the route from the step S64 to the step S66.

Moreover, the system controller 7 receives the sensor signal of the setting value In measured with the voltage/current detector 2 and the setting value In is likely to increase up to the current upper limit value Ib in the step S69. However, when the setting value In is determined to be higher than the current upper limit value Ib, the fuel cell 1 is assumed to be defective.

Therefore, the system controller 7 generates the drive signal D2 for the load switch unit 4 in view of suspending operation of the fuel cell and the load switch unit 4 receives the drive signal D2 and separates the drive load of the drive load unit 8 connected. For the fuel cell suspending process (step S71), the system controller 7 generates the drive signal D1 for the fuel supply system controller 5, and the fuel supply system controller 5 receives the drive signal D1 to conduct termination process such as exhaust process of fuel in the fuel cell.

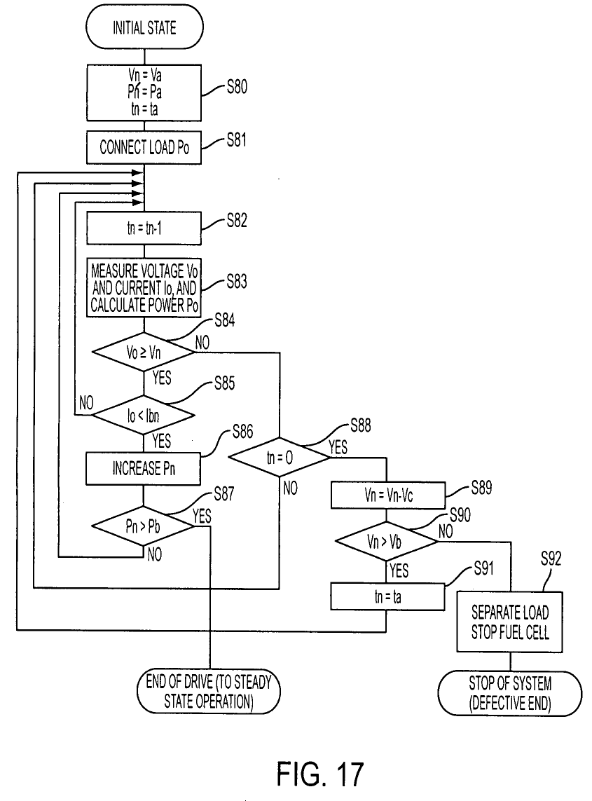

FIG. 17 is a flowchart for explaining operations in the system configuration of FIG. 9 until the fuel cell 1 transfers to the steady state operation from the initial state after completion of control at the time of drive of the fuel cell. The control is conducted with reference to the voltage Vo and the drive control of fuel cell 1 is executed by confirming limitation of the current Io before the drive load in the drive load unit 8 is varied.

Next, the fuel cell drive process within the system configuration in the system of FIG. 9 will be explained by referring to FIG. 17.

Upon determination that the fuel cell 1 is in the initial state, the system controller 7 sets the load power consumption value Pn′ to the load power consumption initial value Pa from the voltage initial value Va×current initial value Ia by setting the voltage Vn to the voltage initial value va and the current In to the current initial value Ia and also sets the initial value ta of the specified time tn (step S80).

The system controller 7 generates the drive signal D2 for the load switch unit 4 and the load switch unit 4 receives the drive signal D2 and connects the load connected to the drive load Pn having variable resistance (step S81).

In the circuit operation where the load switch unit 4 connects the load to the drive load Pn having the variable resistance, when the voltage V1 is set to a low voltage and the voltage V2 to a high voltage as explained by referring to FIG. 11, the current outputted from the fuel cell 1 flows into the drive load Pn of the drive load unit 8.

The system controller 7 measures the present number of times of repetition tn (step S82).

The voltage/current detector 2 measures voltage Vo and current Io to calculate power Po with voltage Vo×current Io (step S83).

The voltage Vo measured is inputted to the system controller 7 as the sense signal. The system controller 7 determines whether the voltage Vo is equal to or higher than the setting value Vn, here the voltage initial value Va (step S84).

When the voltage Vo is equal to or higher than the setting value Vn, the system controller 7 determines whether the current Io measured with the voltage/current detector 2 is lower than the current upper limit value Ibn at each voltage (step S85). When the current Io is higher than the current upper limit value Ibn at each voltage, the process returns to the step S82.

When the current Io is lower than the current upper limit value Ibn at each voltage, the system controller 7 generates the drive signal D3 for increasing step by step the drive load Pn to the drive load unit 8 and the drive load unit 8 receives the drive signal D3 to increase the drive load Pn step by step (step S86).

The drive load unit 8 in FIG. 12A controls the drive load Pn to constant value by varying an internal resistance Rn of the field effect transistor (FET), namely of the drive load Pn. Here, the drive load Pn of the drive load unit 8 can be increased step by step by varying amount of change with the system controller 7 using numerical map or by varying amount of change with input. The system controller 7 generates the drive signal D3 to the drive load unit 8 and the drive load unit 8 having received the drive signal D3 varies the drive load Pn as much as amount of change. The drive load Pn having increased as much as amount of change is maintained in the constant value under the control of FIG. 15.

As explained above, voltage control can be executed without giving sudden change in the fuel cell body when the fuel cell 1 is driven from the initial state by increasing step by step the drive load Pn.

In addition, since the drive load Pn is increased step by step while measuring the current Io, the highly reliable fuel cell device which can realize stable load operation can be achieved.

Moreover, because of step-by-step change, amount of heavy current while the load is varied in every timing for variation of each drive load can be detected easily and familiarization of fuel can also be assumed. Therefore, the optimum familiarization time can be set for each timing of load and it is no longer required to change the load during the unnecessary longer period.

Next, the system controller 7 previously-sets the upper limit value Pb at the time of drive of the load power consumption for the drive load Pn.

The system controller 7 determines whether the drive load Pn has increased up to the upper limit value Pb at the time of drive (step S87).

The system controller 7 continues, upon determination that the drive load Pn is lower than the upper limit value Pb at the time of drive, the drive by returning to the step S82.

Until constant time has passed, the voltage/current detector 2, continuously measures voltage Vo, current Io, and power Po and the measured values are inputted to the system controller 7 as the sense signal.

When the drive load Pn is determined to be higher than the upper limit value b at the time of drive, the system controller 7 generates the drive signal D2 to the load switch unit 4 in order to terminate control at the time of drive of the fuel cell and the load switch unit 4 receives the drive signal D2 and switches the load connected to the load 10 such as personal computer from the drive load of the drive load unit 8 to transfer the state of system to the steady state.

The route up to the step S87 from the step W82 is taken when the voltage Vo rises up to the voltage initial value Va and moreover the current Io is equal to or lower than the current upper limit value Ibn.

Moreover, the system controller 7 having received the values measured with the voltage/current detector 2 in the step S84 by the sense signal determines whether the voltage Vo is equal to or higher than the setting value Vn, here the voltage initial value Va. When the voltage Vo is lower than the setting value Va, the present number of times of repetition tn is determined to be 0 or not (step S88).

When tn is not equal to 0, the process returns to the step S82. Until constant time has passed, the voltage/current detector 2 continuously measure the voltage Vo, current Io and power Po and the measured values are inputted to the system controller 7 as the sense signal.

When the voltage Vo is equal to or lower than the voltage initial value Va from the step S82 to the step S84, the route to return to the step S82 passing the step S88 is taken when the voltage Vo does not rise up to the voltage initial value Va while the present number of times of repetition tn is within the specified number of times of repetition ta.

When tn is equal to 0 in the step S88, the voltage Vo does not rise up to the voltage initial value Va while the present number of times of repetition tn is within the specified number of times of repetition ta. Therefore, the setting value Vn is reduced by amount of change Vc of voltage until it becomes equal to the value of setting value Vn−amount of change of voltage Vc. This value is then set to the new setting value Vn (step S89).

The system controller 7 presets the voltage lower limit Vb for the setting value Vn of voltage. This system controller 7 also receives the sense signal of the setting value Vn measured by the voltage/current detector 2 and determines whether the setting value Vn is equal to or higher than the voltage lower limit value Vb (step S90).

As explained above, the voltage of the fuel cell 1 is reduced little by little in the step of the amount of change of voltage Vc from the voltage initial value Va and is also reduced up the voltage lower limit value Vb which is allowed as the lower limit of voltage.

When the setting value Vn is determined to be higher than the voltage lower limit value Vb, the system controller 7 sets again, in the step S91, the present number of times of repetition tn to the specified number of times of repetition ta. The setting value Vn is changed to the value of setting value Vn−amount of change of voltage Vc and this value is set as the new initial value. Here, the process returns to the step S82.

The system controller 7 having received the values measured with the voltage/current detector 2 by the sense signal determines whether the voltage Vo is equal to or higher than the setting value Vn set as the new initial value, here the value of the setting value Vn−amount of change of voltage Vc.

When the voltage Vo is lower than the setting value Vn which has been set as the new initial value, processes are conducted by taking the route including the steps up to S88 from S84 and the steps up to S91 from S88. In this case, amount of change of voltage Vc is reduced from the setting value Vn, determination is made in the step S84 using the setting value Vn from which the amount of change of voltage Vc has been reduced, and processes are conducted by taking the route including the steps up to S87 from S84.

Moreover, the system controller 7 receives the sensor signal of the setting value Vn measured with the voltage/current detector 2 and the setting value Vn is likely reduced up to the voltage lower limit value Vb in the step S90. However, when the setting value Vn is determined to be lower than the voltage lower limit value Vb, it is assumed as failure of the fuel cell 1 or as a defective state of the fuel cell 1 where the fuel is consumed and thereby the voltage does not rise.

Therefore, the system controller 7 generates the drive signal D2 to the load switch unit 4 in view of suspending operations of the fuel cell and the load switch unit 4 receives the drive signal D2 and separates the drive load of the drive load unit 8 connected.

In order to conduct the fuel cell suspending process (step S92), the system controller 7 generates the drive signal D1 to the fuel supply system controller 5 and the fuel supply system controller 5 receives the drive signal D1 to conduct termination process such as exhaust process of fuel in the fuel cell.

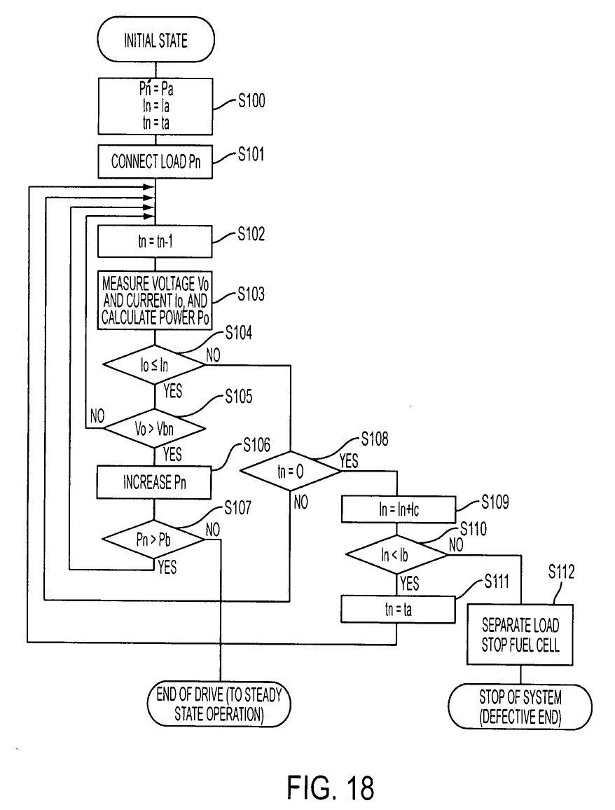

FIG. 18 is a flowchart for explaining operations of system configuration of FIG. 9 until the fuel cell 1 transfers to the steady state from the initial state after termination of control at the time of drive. Drive control of the fuel cell 1 is conducted through control with reference to the current Io and checking the limit of voltage Vo before varying the drive load of the drive load unit 8.

Next, fuel cell drive process in the system configuration of the system of FIG. 9 will be explained by referring to FIG. 18.

When the fuel cell 1 is determined to be in the initial state, the system controller 7 sets the load power consumption value Pn′ to the load power consumption value Pa from voltage initial value Va×current initial value Ia by setting the voltage Vn to the voltage initial value Va and the current In to the current initial value Ia and also sets the specified number of times of repetition ta of the present number of times of repetition tn (step S100).

The system controller 7 generates the drive signal D2 for the load switch unit 4 and the load switch unit 4 receives the drive signal D2 and connects the load connected to the drive load Pn having variable resistance (step S101).

In the circuit operation by the load switch unit 4 for connecting the load to the drive load Pn including variable resistance, when the voltage V1 is set to a low voltage and the voltage V2 to a high voltage as explained by referring to FIG. 11, the current outputted from the fuel cell 1 flows into the drive load Pn of the drive load unit 8.

The system controller 7 measures the specified time tn (step S102).

The voltage/current detector 2 measures voltage Vo and current Io and calculates Po by voltage Vo×Io (step S103).

The current Io measured is inputted to the system controller 7 as the sense signal. The system controller 7 determines here whether the current Io is equal to or lower than the setting value In, here the current initial value Ia (step S104).

When the current Io is lower than the setting value In, the system controller 7 determined whether the voltage Vo measured by the voltage/current detector 2 is higher than the voltage lower limit value Vbn (step S105). When the voltage Vo is lower than the voltage lower limit value Vbn at each current, the process returns to the step S102.

When the voltage Vo is equal to or higher than the voltage lower limit value Vbn at each current, the system controller 7 generates the drive signal D3 to the drive load unit 8 for increasing step by step the drive load Pn and the drive load unit 8 receives the drive signal D3 to increase step by step the drive load Pn (step S106).

In FIG. 12A, the drive load unit 8 controls the drive load Pn to constant value by varying the internal resistance Rn of the field effect transistor (FET), namely of the drive load Pn. Here, the drive load Pn of the drive load unit 8 can be increased step by step by varying amount of change using the numerical map by system controller 7 or by varying amount of change with the input. The system controller 7 generates the drive signal D3 for the drive load unit 8 and the drive load unit 8 having received the drive signal D3 varies the drive load Pn as much as amount of change. The drive load Pn having increased as much as amount of change is maintained to the constant value under the control of FIG. 15 explained above.

As explained above, voltage control can be conducted without giving sudden change to the fuel cell body while the fuel cell 1 transfers to the drive mode from the initial state by increasing step by step the drive load Pn.

Moreover, since the drive load Pn increases step by step while the voltage Vo is measured, the highly reliable fuel cell drive which assures stable load operation can be realized.

In addition, because of step by step change, amount of heavy current while the load is varied can be detected easily in every timing for varying each drive load and the familiarization time of the fuel can also be assumed. Accordingly, the familiarization time can be set to the optimum value in every timing of each drive load and change of load under unnecessarily longer time is no longer required.

Next, the system controller 7 presets the upper limit value Pb of the load power consumption at the time of drive for the drive load Pn.

The system controller 7 determines whether the drive load Pn has increased up to the upper limit value Pb at the time of drive (step S107).

When the drive load Pn is determined to be lower than the upper limit value Pb at the time of drive, the system controller 7 continues the drive by returning to the step S102.

Until constant time has passed, the voltage/current detector 2 continues measurement of voltage Vo, current Io and power Po and the measured values are inputted to the system controller 7 as the sense signal.

When the drive load Pn is determined to be higher than the upper limit value Pb at the time of drive, the system controller 7 generates the drive signal D2 to the load switch unit 4 in order to terminate the control at the time of drive of the fuel cell and the load switch unit 4 receives the drive signal D2 and switches the load connected to the load 10 such as personal computer from the drive load of the drive load unit 8 and transfers the state of system to the steady state.

The route including the steps up to S107 from S102 is taken when the voltage Vo has increased up to the voltage lower limit Vbn.

The system controller 7 having received the values measured with the voltage/current detector 2 in the step S104 using the sense signal determines whether the current Io is equal to or higher than the setting value In, here equal to or lower than the current initial value Ia. When the current Io is higher than the setting value In, the whether the present number of times of repetition tn is 0 or not (step S108). When tn is not equal to 0, the process returns to the step S102. Until constant time has passed, the voltage/current detector 2 continues measurement of voltage Vo, current Io and power Po and the measured values are inputted to the system controller 7 as the sense signal.

When the current Io is equal to or higher than the current initial value Ia in the steps S102 to S104, the route to return to the step S102 via the step S108 is taken when the current Io increases exceeding the current initial value Ia while the present number of times of repetition tn is within the specified number of times of repetition ta.

When tn is equal to 0 in the step S108, the current Io increases exceeding the current initial value Ia while the present number of times of repletion tn is within the specified number of times of repetition ta. Therefore, the setting value In is increased as much as amount of change of current Ic up to the value of setting value In+amount of change of current Ic and this value is then set as the new setting value In (step S109).

The system controller 7 presets the current upper limit value Ib for the setting value In of current. This system controller 7 also determines whether the setting value In is equal to or lower than the current upper limit value Ib by receiving the sense signal of the setting value In measured by the voltage/current detector 2 (step S110).

As explained above, the current is increased up to the current upper limit value Ib which is allowed as the upper limit of current by increasing the amount of change of current Is little by little to the current initial value Ia of the fuel cell 1.

When the setting value In is determined to be lower than the current upper limit value Ib in the step S110, the system controller 7 sets again the present number of times of repetition tn to the specified number of times of repetition ta (Step S111). The setting value In is changed to the setting value In+amount of change of current Ic. This value is then set as the new initial value. The process returns to the step S102.

The system controller 7 having received the values measured with the voltage/current detector 2 using the sense signal determines whether the current Io is equal to or lower than the setting value In which has been set as the new initial value.

When the current Io is higher than the setting value In which has been set as the new initial value, the processes are conducted by taking the route up to the step S108 from the step S104 and the route up to the step S111 from the step S108. In this case, the setting value In is increased as much as amount of change of current Ic, determination is made in the step S104 using the setting value In which has been increased as much as amount of change of current Ic, and the processes are conducted by taking the route up to the step S107 from the step S104.

Moreover, the system controller 7 receives the sensor signal of setting value In measured by the voltage/current detector 2 and the setting value In is likely to increase up to the current upper limit value Ib in the step S110. However, when the setting value In is determined to be higher than the current upper limit value Ib, it is considered as defective state where failure occurs in the fuel cell 1.

Therefore, the system controller 7 generates the drive signal D2 for the load switch unit 4 in view of terminating the fuel cell and the load switch unit 4 receives the drive signal D2 and separates the drive load of the drive load unit 8 connected.

In view of conducting the fuel cell suspending process (step S112), the system controller 7 generates the drive signal D1 for the fuel supply system controller 5 and this fuel supply system controller 5 receives the drive signal D1 to conduct termination process such as exhaust process of fuel in the fuel cell.

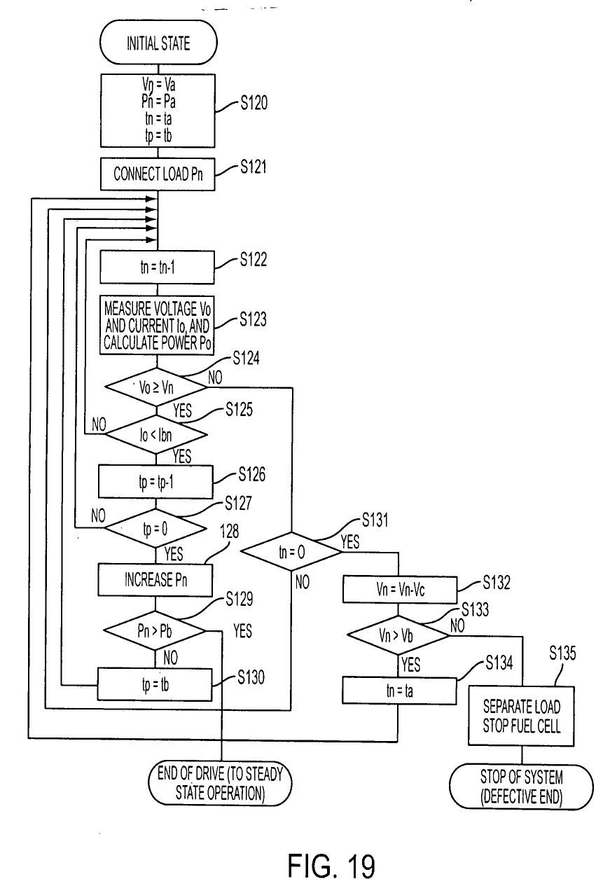

FIG. 19 is a flowchart for explaining operation in the system configuration of FIG. 9 until the fuel cell 1 transfers the steady state from the initial state after termination of control at the time of drive. The control is executed with reference to voltage Vo and drive control of the fuel cell 1 is also executed by checking limitation of the current Io before varying drive load of the drive load unit 8.

Next, the fuel cell drive process in the system configuration of the system of FIG. 9 will be explained by referring to FIG. 19.

When the fuel cell 1 is determined to be in the initial state, the system controller 7 sets the load power consumption value Pn′ to the load power consumption initial value Pa with the voltage initial value Va×current initial value Ia by setting the voltage Vn to the voltage initial value Va and the current In to the current initial value Ia and also sets the specified number of times of repetition ta of the present number of times of repetition tn. Here, ta means a system failure monitoring timer. Moreover, the specified number of times of repetition tb of the present number of times of repetition tp waiting for increase of load is also set. Here, tb means a load increase waiting timer (step S120).

The system controller 7 generates the drive signal D2 for the load switch unit 4 and this drive switch unit 4 receives the drive signal D2 and connects the load connected to the drive load Pn having variable resistance of the drive load unit 8 (step S121).

In the circuit operation of the load switch unit 4 for connecting the load to the drive load Pn having a variable resistance, when the voltage V1 is set to a low voltage and the voltage V2 to a high voltage as explained in FIG. 11, the current outputted from the fuel cell 1 flows into the drive load Pn of the drive load unit 8.

The system controller 7 measures the present number of times of repetition tn (step S122).

The voltage/current detector 2 measures voltage Vo and current Io and calculates power Po from voltage vo×current Io (step S123).

The voltage Vo measured is inputted to the system controller 7 as the sense signal. The system controller 7 determines whether the voltage Vo is equal to or higher than the setting value, here the voltage initial value Va (step S124).

When the voltage Vo is equal to higher than the setting value Vn, the system controller 7 determines whether the current Io measured with the voltage/current detector 2 is lower than the current upper limit value Ibn at each voltage (step S125).

When the current Io is higher than the current upper limit value Ibn at each voltage, the process returns to the step S122.

Moreover, when the current Io is lower than the current upper limit value Ibn at each voltage in the step S125, the system controller 7 measures the present number of times of repetition tp in the load increase waiting mode (step S126).

When the present number of times of repetition tp waiting for load increase is equal to 0 (step S127), the system controller 7 generates the drive signal D3 to increase step by step the drive load Pn to the drive load unit 8 and the drive load unit 8 receives the drive signal D3 to increase step by step the drive load Pn (step S128).

The drive load unit 8 controls, in FIG. 12A explained above, the drive load Pn to constant value by varying the internal resistance Rn in the field effect transistor (FET), namely in the drive load Pn. Here, the drive load Pn of the drive load unit 8 can be increased step by step by varying amount of change by the numerical map with the system controller 7 and by varying amount of change with input. The system controller 7 generates the drive signal D3 to the drive load 8 and the drive load unit 8 having received the drive signal D3 varies the drive load Pn as much as amount of change. Moreover, the drive load Pn having increased as much as amount of change is maintained to constant value under the control of FIG. 15.

Voltage control can be executed giving no sudden change in the fuel cell body while the fuel cell 1 transfers to the drive mode from the initial state by increasing step by step the drive load Pn as explained above.

Moreover, since the drive load Pn is increased step by step while the voltage Vo is measured, the highly stable fuel cell device assuring stable load operation can be realized.

Moreover, because of step by step change, amount of heavy current during variation of load in every timing for varying each drive load can be detected easily and moreover familiarization time of the fuel can be assumed. Accordingly, the optimum familiarization time can be set for each drive load and it is no longer required to vary the load by taking unnecessary longer time.

Next, the system controller 7 presets the upper limit value Pb at the time of drive of the load power consumption for the drive load Pn.

The system controller 7 determines whether the drive load Pn has increased up to the upper limit value Pb at the time of drive (step S129).

Upon determination that the drive load Pn is lower than the upper limit value Pb at the time of drive in the step S129, the system controller 7 sets again the present number of times of repetition tp waiting for increase of load to the specified number of times of repetition tb (step S130). Thereafter, the process returns to the step S122 for continuation of drive.

Moreover, when it is determined in the step S129 that the drive load Pn is higher than the upper limit value Pb at the time of drive, the system controller 7 generates the drive signal D2 to the load switch unit 4 to terminate control at the time of drive of the fuel cell and the load switch unit 4 receives the drive signal D2 and switches the load connected to the load 10 such as personal computer from the drive load of the drive load unit 8 and transfers the state of system to the steady state.

The route up to the step S130 from the step S124 is taken when the voltage Vo rises up to the voltage initial value Va and the current Io is lower than the current upper limit value Ibn.

Moreover, the system controller 7 having received the values measured with the voltage/current detector 2 determines, in the step S124, whether the voltage Vo is equal to or higher than the setting value Vn, here the voltage initial value Va. When the voltage Vo is lower than the setting value Vn, the system controller 7 determines whether the present number of times of repetition tn is 0 (step S131).

When tn is not equal to 0, the process returns to the step S122. Until constant time has passed, the voltage/current detector 2 continuously measures voltage Vo, current Io, and power Po and the measured values are inputted to the system controller 7 as the sense signal.

When the voltage Vo is equal to or lower than the voltage initial value Va in the steps S122 to S124, the route to return to the step S122 via the step S131 is taken when the voltage Vo does not increase up to the voltage initial value Va while the present number of times of repetition tn is within the specified number of times of repetition ta.

Moreover, when the tn is equal to 0 in the step S131, the voltage Vo does not increase up to the voltage initial value Va while the present number of times of repetition tn is within the specified number of times of repetition ta. Therefore, the setting value Vn is reduced as much as the amount of change of voltage Vc and the value of setting value Vn−amount of change of voltage Vc is set as the new setting value (step S132).

The system controller 7 presets the voltage lower limit value Vb for the setting value Vn of voltage. The system controller 7 also receives the sense signal of the setting value Vn measured with the voltage/current detector 2 and determines whether the setting value Vn is equal to or higher than the voltage lower limit value Vb (step S133).

The voltage is lowered up to the voltage lower limit value Vb which is allowed as the lower limit of voltage by reducing little by little amount of change of voltage Vc from the voltage initial value Va of the fuel cell 1 as explained above.

Upon determination that the setting voltage Vn is higher than the voltage lower limit value Vb in the step S133, the system controller 7 resets again the present number of times of repletion tn to the specified number of times of repetition ta (Step S134).

The setting value Vn is changed to the setting voltage−amount of change of voltage Vc and this value is then set as the new initial value. Here, the process returns to the step S122.

The system controller 7 having received the values measured with the voltage/current detector 2 with the sense signal determines whether the voltage Vo is equal to or higher than the setting value Vn set as the new initial value, here the setting value−amount of change of voltage Vc.

When the voltage Vo is lower than the setting value Vn set as the new initial value, the process is executed by taking the route via the step S124 to step S131 and the step 131 to step S134. In this case, the setting value Vn is reduced again as much as the amount of change of voltage Vc, determination is made in the step S124 using the value of setting value Vn reduced as much as the amount of change of voltage Vc, and the process is executed by taking the route of the step S124 to step S129.

Moreover, the system controller 7 receives the sensor signal of the setting value Vn measured with the voltage/current detector 2 and the setting value Vn is likely to be reduced up to the voltage lower limit value Vb in the step S133.

However, when the setting value Vn is determined to be lower than the voltage lower limit value Vb, it is assumed to suggest failure of the fuel cell 1 or defective state of the fuel cell 1 where the fuel is consumed and the voltage does not rise.

Therefore, the system controller 7 generates the drive signal D2 for the load switch unit 4 in view of termination of the fuel cell and the load switch unit 4 receives the drive signal D2 and separates the drive load of the drive load unit 8 connected.

For the fuel cell suspending process (step S135), the system controller 7 generates the drive signal D1 to the fuel supply system controller 5 and the fuel supply system controller 5 receives the drive signal D1 and executes the termination process such as exhaust process of fuel in the fuel cell.

The voltage/current detector 2 continues measurement of voltage Vo, current Io and power Po until constant time has passed and the measured values are inputted to the system controller 7 as the sense signal.

Moreover, the system controller 7 receives the sense signal of the setting value Vn measured with the voltage/current detector 2 in the step S133. When the setting value Vn is determined to be higher than the voltage lower limit value Vb, it is assumed to suggest failure of the fuel cell 1.

Therefore, the system controller 7 generates the drive signal D2 to the load switch unit 4 in view of termination of the fuel cell 1, and the load switch unit 4 receives the drive signal D2 and separates the drive load of the drive load unit 8 connected.

In order to conduct the fuel cell suspending process (step S135) the system controller 7 generates the drive signal D1 to the fuel supply system controller 5, the fuel supply system controller 5 receives the drive signal D1 and executes the terminal process such as exhaust process of the fuel in the fuel cell.

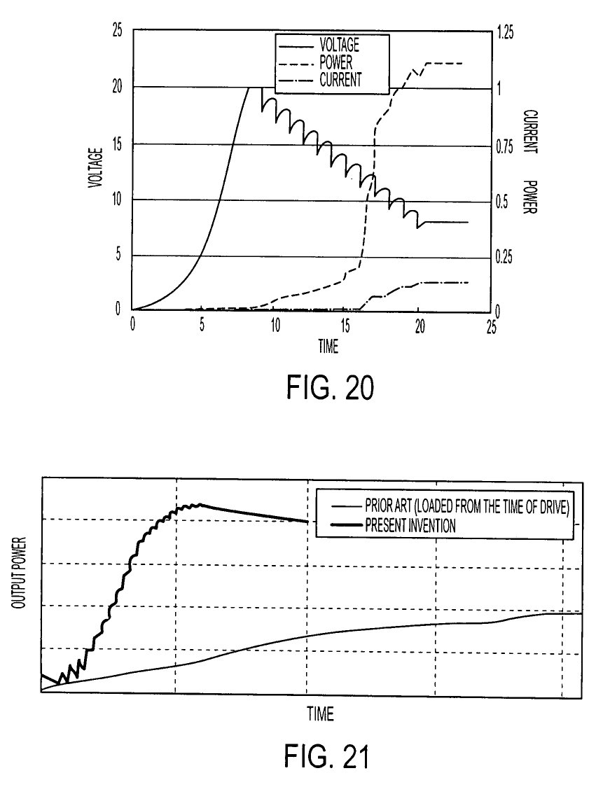

FIG. 20 shows an example of change in the voltage, current and power measured with the voltage/current detector 2 in the system configuration of the system of FIG. 9. Changes in the voltage, current, and power are plotted on the vertical axis, while change in time on the horizontal axis.

In FIG. 20, the times from 0 to 8 of change in time on the horizontal axis show change of voltage, current, and power under the control in the flowchart for recognizing the initial state of fuel cell of FIG. 13. The load switch unit 4 separates both loads of the drive load 8 and the load 10 such as personal computer. The system controller 7 generates the drive signal for supplying the fuel to the fuel cell and the fuel supply system controller receives the drive signal and supplies the fuel and oxygen to the fuel cell.

After the time 8 of change in times on the horizontal axis of FIG. 20, changes in voltage, current, and power under the control of the flowchart for recognizing fuel cell drive process of FIG. 14 are indicated. Since the drive process of fuel cell 1 is executed during the times from 8 to 18 of change in time on the horizontal axis, the load switch unit 4 connects the load to the drive load unit 8 in order to increase step by step the drive load of the drive load unit 8.

At the time 18 in the timing for increasing power, the drive process of the fuel cell is terminated and the load switch unit 4 switches the load to the load 10 such as personal computer from the drive load unit 8.

The time required for drive of the fuel cell 1 can be shortened by increasing step by step the drive load as explained above. Moreover, since the drive load can be increased step by step while measuring the voltage and current, the highly reliable fuel cell device assuring stale load operation can be realized.

FIG. 21 shows example of change in output of the fuel cell when the present invention where the load switch unit 4 separates the load in the initial state of the fuel cell is adopted and when the load is connected from the initial state of the fuel cell.

Change in output power of fuel cell is plotted on the vertical axis, while change in time on the horizontal axis. As shown in FIG. 21, it can be proved that the time required until the target output is achieved can be shortened remarkably through application of the present invention by comparison with the prior art method where the load is connected from the initial state of the fuel cell as shown in FIG. 21.

The present invention discloses the technique for realizing penetration of the liquid fuel into the electrolyte film within the MEA (Membrane Electrode Assembly) in the fuel cell.

The drive process in the present invention indicates the process for transferring the fuel cell to the rated output power generation ready state from the suspending state thereof. The fuel cell suspending state indicates the state where the fuel cell is stored under the moisture condition by removing the fuel element from the MEA.

Moreover, the rated output power generation ready state indicates the state where the MEA is filled with the fuel and the fuel is sufficiently familiarized into the electrolyte film at the center of MEA, namely the state where proton is conductive within the entire part of the electrolyte film.

The prior methods include a method (1) for fixing a load from the driving time and a method (2) for continuously varying the load from the driving time. In the method (1) for fixing the load from the driving time, the time is required until the liquid fuel is naturally penetrated into the electrolyte film for the transfer to the rated output power generation ready state from the fuel cell suspending state. About several hours to several days are required for the fuel cell where the electrolyte film is formed of hydrogen carbide system. Even in the method (2) for continuously varying the load from the driving time, the time is required until the liquid fuel is naturally penetrated into the electrolyte film for the transfer to the rated output power generation ready state from the fuel cell suspending state. Therefore, molecule activity at the area near the electrolyte film becomes active when a load is applied. In this case, heat is generated. In general, the electrolyte film is capable of showing higher performance when temperature is higher. Accordingly, the time required until the fuel is sufficiently familiarized into the electrolyte film tends to be reduced.

However, in the case where change is continuous, it is difficult to know the reason why the output has increased from those listed below. One reason is that a heavy current flows momentarily due to variation of the load. In this case, an output voltage of fuel cell does not change in moment but after the load is changed, the current flows once in a large extent and the current tends to be gradually lowered to the constant value. The other reason is that the fuel is sufficiently familiarized to the electrolyte film with increase of load.

Accordingly, when it is requested to continuously change the load of the fuel, the load must be changed taking sufficiently longer time interval.

However, in the present invention, since the load is varied step by step, amount of heavy current during variation of load for each timing for varying the load can be detected. Moreover, the familiarization time of fuel during variation of load can be assumed. Therefore, the optimum familiarization time can be set for each timing in each variation of load and it is no longer required to change the load in unnecessary longer time.

### Second Embodiment of Drive Process

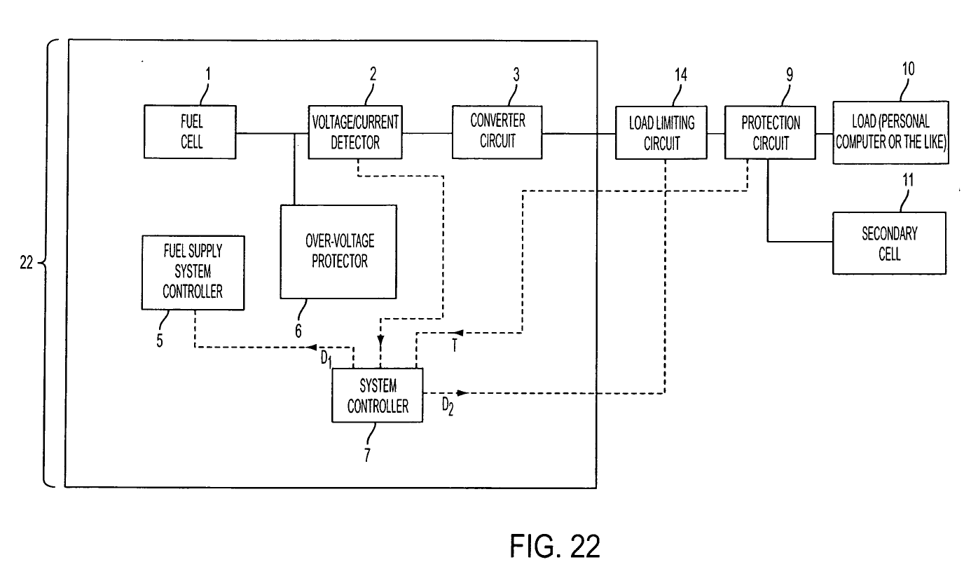

The second embodiment of drive process will be explained with reference to FIG. 22. FIG. 22 shows total system of the fuel cell device of the second embodiment of the present invention. In FIG. 22, the elements like those in FIG. 9 are designated with the like reference numerals. The structure required for control in the steady state is partly eliminated in FIG. 22 as in the case of FIG. 9.

In FIG. 22, the reference numeral 1 designates a fuel cell; 2, a voltage/current detector; 3, a converter circuit; 14, a load limiting circuit; 5, a fuel supply system controller; 6, an over-voltage protector; 7, a system controller; 9, a protection circuit; 10, a load such as personal computer; 11, a secondary cell; and 22, a fuel cell device.

The fuel cell 1 is connected with the voltage/current detector 2 for detecting output voltage and current of the fuel cell, which is connected with the converter circuit 3; connected with the load limiting circuit 14, connected with the protection circuit 9, connected with the load 10 such as the personal computer and the secondary cell 11. Moreover, when the fuel is supplied to the fuel cell 1 and an output voltage of the fuel cell 1 rises, the over-voltage protector 6 is connected between the fuel cell 1 and voltage/current detector 2 for limiting the output voltage thereof. Moreover, in the fuel cell device of the second embodiment of the present invention, the drive load in the fuel cell device of the first embodiment is replaced with the secondary cell and personal computer or the like. Namely, the load limiting circuit 14 may be replaced with the secondary cell or personal computer as the load of the fuel cell when these may be enough as the load in the same degree as the output of fuel cell.

As the fuel supplied to the fuel cell, the fuel supply controller 5 supplies methanol to the fuel cell 1 in accordance with the operating instruction from the system controller 7.

When the fuel cell 1 is driven, the voltage/current detector 2 for detecting output voltage and current of the fuel cell 1 generates the detection signal L by detecting voltage and current of the fuel cell 1. The detection signal L is inputted to the system controller 7 as the control information. The system controller 7 receives the detection signal L and generates the drive signals D1 and D2. The fuel supply system controller 5 controls supply of the fuel to the fuel cell and starts supply of the fuel to the fuel cell by receiving the drive signal D1. The load limiting circuit 14 limits the load to which the output voltage and current of the fuel cell flow by increasing the load step by step. Moreover, the load limiting circuit 14 also switches the load to the load 10 such as personal computer.

The load limiting circuit 14 receives the drive signal D2 and increases step by step the load thereof. Moreover, the load limiting circuit 14 varies the load based on the constant ratio of voltage and current.

In addition, the load 10 such as personal computer is affected by voltage drop pr surge due to sudden power generation and suspension of operation of the fuel cell 1. In order to prevent a failure of the power supply circuit and mother board of the personal computer due to such influence, the protection circuit 9 generates the stop signal T and this stop signal T is added to the system controller 7 as the control information. This system controller 7 is formed of a microprocessor and executes supply of fuel, stop of fuel supply, and load control for the fuel cell 1.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A fuel cell device for supplying electrical power to a load from a fuel cell, comprising:
a determining unit determining a steady state of said fuel cell in which a fuel of said fuel cell is circulated and the electrical power generated by said fuel cell reaches a specified power,
a measuring unit measuring fuel temperature in said fuel cell,
a fuel storing unit storing the fuel to be supplied to said fuel cell, and
a control unit controlling concentration of the fuel stored in said fuel storing unit on the basis of the fuel temperature measured by said measuring unit after the steady state of said fuel cell is determined by said determining unit.

2. The fuel cell device according to claim 1, further comprising:
water-level detecting unit detecting the remaining amount of fuel stored in said fuel storing unit as a water-level, wherein said control unit includes a concentration control unit controlling concentration of the fuel stored in said fuel storing unit on the basis of a temperature difference between the fuel temperature measured with said measuring unit and an adequate temperature of said fuel cell when the water level detected with said water-level detecting unit is lower than a predetermined water level.

3. The fuel cell device according to claim 2, wherein said concentration control unit supplies high concentration fuel to said fuel storing unit when the fuel temperature measured with said measuring unit is determined to be lower than the adequate temperature of said fuel cell and said concentration control unit supplies dilute solution to said fuel storing unit when the fuel temperature measured with said measuring unit is determined to be higher than the adequate temperature of said fuel cell.

4. The fuel cell device according to claim 1, further comprising:
a load for drive,
a load switch connecting any of the load for steady state and said load for drive to said fuel cell, and
a load adjuster adjusting a value of said load for drive, wherein
said load switch connects said load for drive to said fuel cell at the time of drive of said fuel cell,
said load adjuster increases said load for drive, step by step, and
said load switch switches, when said load for drive reaches the specified value, the load of said fuel cell to said load for steady state from said load for drive.

5. The fuel cell device according to claim 4, wherein said load adjuster limits an increase of said load for drive, in a case that an output current of said fuel cell is equal to or higher than a specified current value.

6. The fuel cell device according to claim 5, wherein said load adjuster limits increases of said load for drive, in a case that an output voltage of said fuel cell is equal to or lower than a specified voltage value.

7. A controller of a fuel cell device including a fuel storing unit storing the fuel to be supplied to a fuel cell to supply electrical power from said fuel cell to a load, said controller comprising:
determining unit determining a steady state of said fuel cell when the fuel is circulated to said fuel cell, electrical power from said fuel cell is measured and the measured power reaches a specified power,
measuring fuel temperature in said fuel cell
a control unit controlling concentration of the fuel stored in said fuel storing unit on the basis of the fuel temperature measured by said measuring unit after the steady state of said fuel cell is determined by said determining unit.

8. The controller according to claim 7, further comprising:
load switch connecting any of the load for steady state and a load for drive to said fuel cell as said load; and
a load adjuster adjusting a value of said load for drive, wherein
said load switching controller connects said load for drive to said fuel cell at the time of drive of said fuel cell,
said load adjusting controller increases said load for drive step by step, and
said load switch switches, when said load for drive reaches the specified value, the load of said fuel cell to said load for steady state from said load for drive

9. A control method of a fuel cell device, including measuring a fuel temperature of a fuel in a fuel cell and storing the fuel to be supplied to said fuel cell, comprising:
determining a steady state of said fuel cell in which electrical power reaches a specified power by measuring the electrical power from said fuel cell after the fuel is circulated into said fuel cell, and
controlling concentration of the stored fuel on the basis of the measured fuel temperature when said steady state is determined.

10. A control method of a fuel cell device according to claim 9, wherein
said fuel cell device including a load for steady state and a load for drive as a load of said fuel cell, further comprising:
connecting said drive load to said fuel cell when said fuel cell is driven,
increasing said load for drive step by step, and
switching the load of said fuel cell to said load for steady state from said load for drive when said load for drive reaches a specified value.

11. A computer-readable medium storing a control program for a fuel cell device including a measuring unit measuring fuel temperature in a fuel cell and a fuel storing controller storing a fuel supplied to said fuel cell in order to supply electrical power to a load from said fuel cell, wherein said control program causes said fuel cell device to execute:
determining a steady state of said fuel cell in which electrical power reaches a specified power by measuring the electrical power from said fuel cell after the fuel is circulated into said fuel cell, and
controlling a concentration of the fuel stored in said fuel storing unit on the basis of the fuel temperature measured with said measuring unit after said steady state is determined.

12. The computer-readable medium according to claim 11, wherein
said fuel cell device including a load for steady state and a load for drive as said load,
said control program causes said fuel cell device to execute:
connecting said drive load to said fuel cell when said fuel cell is driven,
increasing said load for drive step by step, and
switching the load of said fuel cell to said load for steady state from said load for drive when said load for drive reaches the specified value.
